(19) United States
(12) Patent Application Publication
(10) Pub. No.: US 2018/0083247 A1
(43) Pub. Date: Mar. 22, 2018

(54) MULTILAYER POROUS FILM, BATTERY SEPARATOR, AND BATTERY

(71) Applicant: Mitsubishi Chemical Corporation, Chiyoda-ku (JP)

(72) Inventors: Masayuki SEO, Chiyoda-ku (JP); Hiroto YAMADA, Chiyoda-ku (JP); Takatoshi MUTA, Chiyoda-ku (JP); Tomoyuki NEMOTO, Chiyoda-ku (JP)

(73) Assignee: Mitsubishi Chemical Corporation, Chiyoda-ku (JP)

(21) Appl. No.: 15/563,351

(22) PCT Filed: Apr. 1, 2016
(86) PCT No.: PCT/JP2016/060889

§ 371 Date: Sep. 29, 2017

(30) Foreign Application Priority Data
Apr. 1, 2015 (JP) 2015-075154
Apr. 15, 2015 (JP) 2015-083460

(51) Int. Cl. H01M 2/16; H01M 2/14

(52) U.S. Cl. CPC H01M 2/1686; H01M 2/166; H01M 2/1653; H01M 2/145

(57) ABSTRACT

A multilayer porous film having excellent air permeability, a capability of being formed with high stability and high efficiency, enhanced ionic permeability, and a low electric resistance is provided. The film includes at least two layers that are a porous layer (layer I) including a polypropylene resin (A) as a main component and a heat-resistant layer (layer II) including a resin composition (II), the resin composition (II) including a polypropylene resin (A), inorganic particles (B), and a vinyl aromatic elastomer (C), the vinyl aromatic elastomer (C) having a melt flow rate (MFR) of 1 g/10 min or less as determined at 230° C. with a load of 2.16 kg.

### TECHNICAL FIELD

The present invention relates to a multilayer porous film, and a battery separator and a battery that include the multilayer porous film.

The first invention relates to a multilayer porous film that has, in particular, when used as a separator for lithium-ion secondary batteries, excellent air permeability that contributes to the battery performance and excellent electric resistance as a result of porous structure control, which enhances the functionality of the battery, and to a battery separator and a battery that include such a multilayer porous film.

The second invention relates to a multilayer porous film that has, in particular, when used as a separator for lithium-ion secondary batteries, excellent air permeability that contributes to the battery performance and an excellent thermal shrinkage characteristic during the heat generation in the battery, which is important from a safety viewpoint, and to a battery separator and a battery that include such a multilayer porous film.

### BACKGROUND ART

Secondary batteries have been widely used as power sources for OA, FA, electric home appliances, and portable devices such as communication devices. In particular, portable devices that include lithium-ion secondary batteries are becoming widespread because these batteries achieve a high volume efficiency when mounted on the devices and consequently enables reductions in the size and weight of the devices.

Large secondary batteries have been studied and developed in various fields related to energy and environmental issues, such as load leveling, UPS, and electric vehicles. Lithium-ion secondary batteries, which are a type of nonaqueous electrolytic solution secondary battery, are becoming widespread because of high capacity, high power, high voltage, and excellent long-term storage stability.

The operating voltage of lithium-ion secondary batteries is typically up to 4.1 to 4.2 V. Since aqueous solutions are electrolyzed at such high voltages, they cannot be used as an electrolytic solution. Accordingly, electrolytic solutions that include organic solvents, that is, nonaqueous electrolytic solutions, which are resistant to high voltages have been used.

Known examples of solvents for nonaqueous electrolytic solutions include a high-dielectric-constant organic solvent, in which a larger amount of lithium ions can be present. A common example of the high-dielectric-constant organic solvent is an organic carbonic acid ester, such as polypropylene carbonate or ethylene carbonate. The solvent includes a highly reactive electrolyte, such as lithium hexafluorophosphate, dissolved therein. This electrolyte is a support electrolyte that serves as a lithium-ion source in the solvent.

A lithium-ion secondary battery includes a battery separator interposed between positive and negative electrodes in order to prevent an internal short circuit. The battery separator is naturally required to have an insulation property because of the role thereof. The battery separator is also required to have a microporous structure that provides air permeability with which lithium ions are capable of permeating through the separator and that enables the electrolytic solution to diffuse and retain inside the separator. To meet the above requirements, a porous film has been used as a battery separator.

It is desirable that a separator for lithium-ion secondary batteries have a high level of safety and a low electric resistance. The high level of safety of a battery separator refers to a capability of the battery separator to, even when an anomaly occurs in a lithium-ion secondary battery and the battery runs into thermal runaway, maintain an insulation property, be resistant to breakage or shrinkage, and prevent the occurrence of a short circuit between the electrodes in order to reduce the occurrence of an accident caused by abnormal heat generation in the battery, such as ignition. Known examples of such a highly safe separator include a separator produced by charging inorganic particles into a resin composition and forming the resin composition into a porous film; a separator produced by coating a porous film with a solution containing inorganic particles; and porous films produced by adding a heat-resistant resin having a high melting point to the above separators. For reducing the electric resistance of the separator in order to enhance the discharge performance of the battery at a large amount of current or a low temperature, it is also necessary to reduce, to a minimum level, resistance to ions that flow inside the separator impregnated with an electrolytic solution. Accordingly, a separator that has a low electric resistance when impregnated with an electrolytic solution has been anticipated. There has been an increasing demand for a porous film for battery separators which has improved ionic permeability and a low electric resistance in order to enhance the performance of batteries and the efficiency of the production of batteries.

Since a battery separator is interposed between two electrode materials, that is, positive and negative electrodes, in a lithium-ion secondary battery, a battery separator is in contact with the positive and negative electrodes with an electrolytic solution interposed between each electrode and the separator. A typical positive electrode material for lithium-ion secondary batteries is a metal oxide. A typical negative electrode material for lithium-ion secondary batteries is a carbon material. Since the positive electrode material and the negative electrode material are a metal oxide and a carbon material, the positive and negative electrodes have a relatively rough surface. This greatly affects the separator, which is in contact with the positive and negative electrodes with an electrolytic solution interposed between each electrode and the separator. In the case where the separator is in contact with the positive and negative electrodes as described above, the separator is required to maintain, even when an anomaly occurs in the lithium-ion secondary battery and the battery runs into thermal runaway, an insulation property, be resistant to breakage or shrinkage, and prevent the occurrence of a short circuit between the electrodes in order to reduce the occurrence of an accident caused by abnormal heat generation in the battery, such as ignition.

As a film having a microporous structure which can be used as a battery separator, JP H10-50287 A (PTL 1) proposes an inorganic-substance-containing porous film having excellent heat resistance, which is composed of a polyolefin resin and an inorganic powder and/or inorganic fibers.

JP H6-100720 A (PTL 2) proposes a method in which the β-crystals, which are one of the crystalline forms of polypropylene, are added to a polypropylene resin and the resulting polypropylene film is stretched to form a porous film in order to enhance the permeability of the porous film.

JP 2012-22911 A (PTL 3) proposes a multilayer porous film including a particle layer composed of inorganic particles and a thermoplastic resin and porous layers composed of a polyolefin resin which are disposed on the respective surfaces of the particle layer. JP 2009-185093 A (PTL 4) proposes a method in which two layers that are a layer including inorganic particles and a layer not including inorganic particles are formed into a separator by coextrusion.

JP 2012-131990 A (PTL 5) and JP 2012-92213 A (PTL 6) propose a porous film composed of a polyolefin resin in which inorganic particles and an elastomer are added. It has been described that adding the elastomer to the porous film enhances the mechanical strength of the film.

As for the coefficient of friction of the porous film, JP 2012-128979 A (PTL 7) proposes a separator including a polyolefin resin porous layer and a heat-resistant layer composed of a high-molecular compound having a melting point of 200° C. or more. It has been described that controlling the coefficient of static friction of the separator enables, for example, a reduction in a misalignment between the separator and each electrode, which may occur with a change in the volume of the active material which occurs during charging and discharging, and, consequently, enhancement of the cycle characteristics of the separator.

PTL 1: JP H10-50287 A

PTL 2: JP H6-100720 A

PTL 3: JP 2012-22911 A

PTL 4: JP 2009-185093 A

PTL 5: JP 2012-131990 A

PTL 6: JP 2012-92213 A

PTL 7: JP 2012-128979 A

1) In the separator proposed in PTL 1, the inorganic particles are included in the entire porous film. This increases the likelihood of a coarse pore structure that originates the inorganic particle being formed when the porous film is stretched and may degrade the mechanical strength of the porous film.

2) The heat resistance of the porous film proposed in PTL 2 may be insufficient for use as a battery separator. There is room to improve the porous film in order to enhance the safety of a battery.

3) It has been described in PTL 3 and PTL 4 that the multilayer separator proposed in PTL 3 and the polyolefin microporous membrane proposed in PTL 4 have excellent heat resistance since they include a porous layer containing inorganic particles. However, it is considered that batteries including these porous films have a high electric resistance because the porous films have a relatively high resistance to air permeation compared with the entire thickness of the porous film. Thus, there is room to improve the multilayer separator proposed in PTL 3 and the polyolefin microporous membrane proposed in PTL 4.

4) It has been described in PTL 5 and PTL 6 that the addition of the elastomer increases the elongation retention rate in PTL 5 and tearing strength in PTL 6. However, the impacts of the addition of the elastomer on the formation of the pores are not studied in PTL 5 and PTL 6. Accordingly, there is room to improve the porous film in terms of electric resistance, which is greatly affected by a porous structure and the degree of communication between the pores.

5) The method for producing a porous film proposed in PTL 1, PTL 4, and PTL 7 includes mixing a plasticizer with a polyolefin resin and inorganic particles, forming the resulting mixture into a sheet-like form (primary work), and forming pores in the sheet by stretching, rolling, or the like (secondary work). The method also requires a step in which, subsequent to the secondary work, the plasticizer is removed with an organic solvent by extraction. This extraction step requires a large amount of organic solvent or the like, which is not preferable from an environmental viewpoint and may degrade the production efficiency.

6) It has been described in PTL 3 that the multilayer separator proposed in PTL 3 has excellent heat resistance since it includes an intermediate layer that is a heat-resistant layer containing inorganic particles. However, there is a risk of a short circuit occurring when the separator is thermally shrunk as a result of an anomaly occurring in the battery and the battery running into thermal runaway.

7) The polyolefin microporous membrane proposed in PTL 4 includes a layer containing polypropylene and polyethylene and a layer containing inorganic particles. However, the use of polyethylene, which has a lower melting point than polypropylene, is disadvantageous in consideration of thermal shrinkage characteristics at high temperatures, which are responsible for the safety of a battery. Thus, there is room to improve the polyolefin microporous membrane proposed in PTL 4.

8) The separator proposed in PTL 7 does not necessarily include an inorganic filler. Furthermore, the advantageous effects of the addition of the inorganic filler are not clarified in PTL 7. In addition, only the relationship between the coefficient of static friction of the heat-resistant porous layer and the cycle characteristics of a battery is studied in PTL 7, while any consideration is given to the importance of the relationship between a porous film having a specific coefficient of kinetic friction and thermal shrinkage characteristics at high temperatures.

9) As described above, a porous film suitably used as a battery separator is required to have excellent air permeability, excellent productivity, and excellent heat resistance. There has been a particularly strong demand for a battery capable of maintaining a high level of safety at high temperatures. Summary of Invention

The first invention was made in light of the issues 1) to 5) above. It is an object of the first invention to provide a multilayer porous film having excellent air permeability, a capability of being formed with high stability and high efficiency, enhanced ionic permeability, and a low electric resistance, a method for producing such a multilayer porous film, and a battery separator and a battery that include the multilayer porous film.

The inventors of the present invention conducted extensive studies in order to achieve the above object and, as a result, found that the above issues may be addressed by a multilayer porous film that includes at least two layers that are a porous layer (layer I) including a polypropylene resin (A) as a main component and a heat-resistant layer (layer II) composed of a resin composition including a polypropylene resin (A), inorganic particles (B) and, a specific vinyl aromatic elastomer (C). Thus, the first invention was made.

Specifically, the first invention is as follows.
[1] A multilayer porous film comprising at least two layers including a first layer and a second layer, wherein the first layer is a porous layer (layer I) including a polypropylene resin (A) as a main component, the second layer is a heat-resistant layer (layer II) including a resin composition (II), the resin composition (II) includes a polypropylene resin (A), inorganic particles (B), and a vinyl aromatic elastomer (C), and the vinyl aromatic elastomer (C) has a melt flow rate (MFR) of 1 g/10 min or less as determined at 230° C. with a load of 2.16 kg.
[2] The multilayer porous film according to [1], wherein the amount of the vinyl aromatic elastomer (C) is 1 to 30 parts by mass relative to 100 parts by mass of the resin composition (II).
[3] The multilayer porous film according to [1] or [2], wherein the porous layer (layer I) has β-crystal activity.
[4] The multilayer porous film according to any one of [1] to [3], wherein the porous layer (layer I) includes a β-phase-nucleating agent.
[5] The multilayer porous film according to any one of [1] to [4], wherein the multilayer porous film is a stretched film.
[6] The multilayer porous film according to any one of [1] to [5], wherein the multilayer porous film has a degree of air permeation of 100 sec/100 ml or less as determined at 25° C. in accordance with JIS P8117 (2009).
[7] The multilayer porous film according to any one of [1] to [6], wherein an electric resistance of the multilayer porous film in a thickness direction is 0.7 Ω or less as determined at 25° C. after the multilayer porous film has been impregnated with a solution containing propylene carbonate and ethyl methyl carbonate at a ratio of 1:1 (v/v), the solution containing 1 M lithium perchlorate.
[8] A battery separator comprising the multilayer porous film according to any one of [1] to [7].
[9] A battery comprising the battery separator according to [8]. [10] A method for producing the multilayer porous film according to any one of [1] to [7], wherein the method comprises: a step of coextruding a polypropylene resin composition for constituting the layer I and the resin composition (II) including the polypropylene resin (A), the inorganic particles (B), and the vinyl aromatic elastomer (C) for constituting the layer II whereby forming a multilayer nonporous film-like material; and a step of stretching the multilayer nonporous film-like material at least uniaxially to make the material porous, and wherein the method does not comprise a step in which additives are removed with a solvent.

The second invention was made in light of the above issues 1), 2), and 5) to 9). It is an object of the second invention to provide a multilayer porous film having excellent air permeability, an excellent thermal shrinkage characteristic at high temperatures, and a capability of being produced with high efficiency and enhancing the safety of a battery, a method for producing such a multilayer porous film, and a battery separator and a battery that include the multilayer porous film.

The inventors of the present invention conducted extensive studies in order to achieve the above object and, as a result, found that the above issues may be addressed by a multilayer porous film that includes a polypropylene resin porous layer (layer i) and a specific heat-resistant layer (layer ii) that are arranged in a particular manner, the surface of the layer ii having a specific coefficient of kinetic friction. Thus, the second invention was made.

Specifically, the second invention is as follows.
[11] A multilayer porous film comprising at least three layers including a layer i and layers ii, the layer i and the layers ii being stacked in an order of the layer ii/the layer i/the layer ii, wherein the layer i is a polypropylene resin porous layer, wherein the layers ii are heat-resistant layers each including 20 to 80 parts by mass of polypropylene resin and 80 to 20 parts by mass of inorganic particles (relative to 100 parts by mass of the total amount of the polypropylene resin and the inorganic particles), and wherein a surface of each of the layers ii has a coefficient of kinetic friction of 0.6 or more on a polyethylene terephthalate film having an arithmetic average roughness Ra of 0.3 μm or less as determined in accordance with JIS K7125 (1999).
[12] The multilayer porous film according to [11], wherein the polypropylene resin porous layer (layer I) has β-crystal activity.
[13] The multilayer porous film according to [11] or [12], wherein the polypropylene resin porous layer (layer I) includes a β-phase-nucleating agent.
[14] The multilayer porous film according to any one of [11] to [13], the multilayer porous film being a stretched film.
[15] The multilayer porous film according to any one of [11] to [14], wherein an area shrinkage of the multilayer porous film which occurs when the multilayer porous film is heated to 200° C. is 10% or less.
[16] A battery separator comprising the multilayer porous film according to any one of [11] to [15].
[17] A battery comprising the battery separator according to [16].
[18] A method for producing the multilayer porous film according to any one of [11] to [15], wherein the method comprises: a step of coextruding a polypropylene resin composition for constituting the layer i and a resin composition including 20 to 80 parts by mass of the polypropylene resin and 80 to 20 parts by mass of the inorganic particles for constituting the layer ii whereby forming a multilayer nonporous film-like material such that the multilayer nonporous film-like material has a structure including the layer ii, the layer i, and the layer ii stacked in this order; and a step of stretching the multilayer nonporous film-like material at least uniaxially to make the material porous, and wherein the method does not comprise a step in which additives are removed with a solvent.

### Advantageous Effects of Invention

The multilayer porous film according to the first invention, which includes the specific porous layer (layer I) and the specific heat-resistant layer (layer II), the layer II including the inorganic particles (B) and the vinyl aromatic elastomer (C) having the specific MFR, has pores highly communicated with one another, which provides excellent air permeability, and high ionic permeability, which results in a low electric resistance. The multilayer porous film according to the first invention also has excellent heat resistance. Therefore, using the multilayer porous film according to the first invention as a battery separator enhances the efficiency and safety of a battery.

The multilayer porous film according to the second invention, which includes at least three layers that are the layer ii, the layer i, and the layer ii stacked on top of one another in this order, the surface of the layer ii having the specific coefficient of kinetic friction, may reduce a misalignment between the separator that is the multilayer porous film according to the second invention and each electrode inside the battery. The multilayer porous film according to the second invention may also reduce the shrinkage of the separator which occurs as a result of abnormal heat generation in the lithium-ion secondary battery. This prevents the occurrence of a short circuit between the electrodes and enhances the safety of a battery.

The multilayer porous films according to the first invention and the second invention can be produced by melt-kneading raw materials, forming the resulting resin composition into a nonporous film-like material, and forming pores in the film-like material by stretching the film-like material at least in an uniaxial direction without strictly controlling the production conditions. In addition, the above production method does not require a step in which additives are removed with a solvent. This enhances productivity and reduces negative impacts on the environment.

### BRIEF DESCRIPTION OF DRAWINGS

FIG. 1 is a schematic cut-off perspective view of a battery including the multilayer porous film according to the present invention.

FIG. 2 includes diagrams illustrating a method for fixing the multilayer porous film in a wide-angle X-ray diffraction analysis.

### DESCRIPTION OF EMBODIMENTS

Embodiments of the present invention are described in detail below. The description of the elements is merely an example (representative example) of an embodiment of the present invention. The present invention is not limited by the following embodiments and may be altered appropriately without departing from the scope of the present invention.

1) Multilayer Porous Film According to First Invention

A multilayer porous film according to an embodiment of the first invention is described below.

1-1. Porous Layer (Layer I)

The porous layer (layer I) included in the multilayer porous film according to the first invention is a layer including a polypropylene resin (A) as a main component and formed using a polypropylene resin composition (hereafter, may be referred to as “resin composition (I)”) including the polypropylene resin (A) as a main component. The porous layer (layer I) is preferably a layer composed of a resin composition (I) including the polypropylene resin (A) and a β-phase-nucleating agent (D) and is a homogeneous porous film formed by stretching due to β-crystal activity.

The term “main component” used herein refers to a component of the porous layer (layer I) or the resin composition (I) the content of which is preferably 50% by mass or more, is more preferably 80% by mass or more, and is further preferably 90% by mass or more.

1-1-1. Polypropylene Resin (A)

Examples of the polypropylene resin (A) used in the first invention include homopolypropylene (i.e., propylene homopolymer); and a random or block copolymer of propylene with an α-olefin, such as ethylene, 1-butene, 1-pentene, 1-hexene, 1-heptene, 1-octene, 1-nonene, or 1-decene. Among the above polypropylene resins, homopolypropylene is suitably used in consideration of mechanical strength.

The isotactic pentad fraction of the polypropylene resin (A), which is a measure for stereoregularity, is preferably 80% to 99%, is more preferably 83% to 98%, and is further preferably 85% to 97%. When the isotactic pentad fraction of the polypropylene resin (A) is 80% or more, a mechanical strength is not reduced. The upper limit of the isotactic pentad fraction of the polypropylene resin (A) is set on the basis of the upper limit of isotactic pentad fraction that can be industrially achieved at present and not limited to this in the case where resins having further high regularity are industrially produced in future.

The term “isotactic pentad fraction” refers to a conformation constituted by continuous five propylene units in which the side chains, that is, five methyl groups, are located in the same direction across the backbone, that is the carbon-carbon bonds or the fraction of such a conformation. The signal assignment of a methyl group region is performed in accordance with A. Zambelli et al. (Macromo1.8,687 (1975)).

The Mw/Mn of the polypropylene resin (A), which is a parameter for molecular weight distribution, is preferably 1.5 to 10.0, is more preferably 2.0 to 8.0, and is further preferably 2.0 to 6.0. The smaller the Mw/Mn, the narrower the molecular weight distribution. When the Mw/Mn of the polypropylene resin (A) is 1.5 or more, sufficiently high extrusion formability is achieved, which enables industrial mass production. When the Mw/Mn of the polypropylene resin (A) is 10.0 or less, a sufficiently high mechanical strength may be achieved.

The Mw/Mn of the polypropylene resin (A) is determined by GPC (gel permeation chromatography).

In general, the melt flow rate (MFR) of the polypropylene resin (A) is preferably, but not limited to, 0.5 to 15 g/10 min and is more preferably 1.0 to 10 g/10 min. When the MFR of the polypropylene resin (A) is 0.5 g/10 min or more, a sufficiently high melt viscosity may be achieved during the formation of the film, which enhances productivity. When the MFR of the polypropylene resin (A) is 15 g/10 min or less, a sufficiently high strength may be achieved.

The MFR of the polypropylene resin (A) is measured at 230° C. with a load of 2.16 kg in accordance with JIS K7210-1 (2014).

The method for producing the polypropylene resin (A) is not limited. It is possible to use a publicly known polymerization method in which a publicly known polymerization catalyst is used, such as a polymerization method in which a multi-site catalyst such as a Ziegler-Natta catalyst or a single-site catalyst such as a metallocene catalyst is used.

The polypropylene resin (A) may be a commercial polypropylene resin. Examples thereof include “NOVATEC PP” and “WINTEC” (produced by Japan Polypropylene Corporation); “NOTIO” and “TAFMER XR” (produced by Mitsui Chemicals, Inc.); “ZELAS” and “THERMORUN” (produced by Mitsubishi Chemical Corporation), “SUMITOMO NOBLEN” and “TAFCELENE” (produced by Sumitomo Chemical Co., Ltd.); “Prime Polypro” and “Prime TPO” (produced by Prime Polymer Co., Ltd.); “Adflex”, “Adsyl”, and “HMS-PP (PF814)” (produced by SunAllomer Ltd.); and “VERSIFY” and “INSPIRE” (produced by Dow Chemical Company).

Only one type of the polypropylene resin (A) may be used alone. Two or more types of polypropylene resins (A) having different compositions or different physical properties may also be used in a mixture.

In the multilayer porous film according to the first invention, the porous layer (layer I) preferably has β-crystal activity. The β-crystal activity of the porous layer is considered to be an index indicating that the polypropylene resin was in the β-crystal form in the unstretched film-like material. When the polypropylene resin included in the unstretched film-like material is in the β-crystal form, it is possible to form fine and uniform pores in the film by subsequently stretching the film-like material without using an additive such as a filler. As a result, a multilayer porous film having a high mechanical strength, excellent air permeability, and is capable of enhancing the characteristic of a battery including the multilayer porous film as a battery separator.

The multilayer porous film according to the first invention is considered to have “β-crystal activity” in the case where a crystal melting peak temperature resulting from the β-crystals of the polypropylene resin is detected by differential scanning calorimetry described in (1) below and/or in the case where a diffraction peak resulting from the β-crystals is detected by X-ray diffraction analysis described in (2) below.

The β-crystal activity of the polypropylene resin is determined by analyzing the states of all the layers constituting the multilayer porous film according to the first invention.

(1) Case Where Differential Scanning Calorimeter Is Used

In a differential scanning calorimeter, the temperature of the multilayer porous film is increased from 25° C. to 240° C. at a heating rate of 10 ° C./min, then held for 1 minute. The temperature of the multilayer porous film is subsequently reduced from 240° C. to 25° C. at a cooling rate of 10 ° C./min and then held for 1 minute. The temperature of the multilayer porous film is again increased from 25° C. to 240° C. at a heating rate of 10 ° C./min. It is considered that the multilayer porous film has β-crystal activity in the case where the crystal melting peak temperature (Tmβ) resulting from β-crystals of the polypropylene resin is detected in the reheating process.

The degree of β-crystal activity is calculated using the formula below on the basis of the amount of heat of fusion (ΔHmα) resulting from α-crystals of polypropylene resin and the amount of heat of fusion (ΔHmβ) resulting from β-crytals of polypropylene resin.

Degree of β-crystal activity (%)=[ΔHmβ/(ΔHmβ+ΔHmα)]×100

For example, in the case where the polypropylene resin is homopolypropylene, the degree of β-crystal activity is calculated on the basis of the amount of heat of fusion (ΔHmβ) resulting from β-crystals which is detected primarily in a range of 145° C. or more and less than 160° C. and the amount of heat of fusion (ΔHmα) resulting from α-crystals which is detected primarily in a range of 160° C. or more and 170° C. or less. In the case where the polypropylene resin is a polypropylene random copolymer including 1 to 4 mol % ethylene, the degree of β-crystal activity is calculated on the basis of the amount of heat of fusion (ΔHmβ) resulting from β-crystals which is detected primarily in a range of 120° C. or more and less than 140° C. and the amount of heat of fusion (ΔHmα) resulting from α-crystals which is detected primarily in a range of 140° C. or more and 165° C. or less.

The degree of β-crystal activity of the porous layer (layer I) is preferably large. Specifically, the degree of β-crystal activity of the porous layer (layer I) is 20% or more, is more preferably 40% or more, and is further preferably 60% or more. When the degree of β-crystal activity of the porous layer (layer I) is 20% or more, a large amount of β-crystals of the polypropylene resin can be formed in the unstretched film-like material. When such a film-like material is stretched, a number of fine and uniform pores can be formed in the film. As a result, a multilayer porous film having a high mechanical strength and excellent air permeability can be produced.

The upper limit of the degree of β-crystal activity is not limited. The upper limit of the degree of β-crystal activity is not limited but preferably close to 100% because the higher the degree of β-crystal activity, the greater the advantageous effects.

(2) Case Where X-Ray Diffractometer Is Used

In the case where the presence of β-crystal activity is determined from a diffraction profile obtained by the wide-angle X-ray diffraction analysis of a multilayer porous film that has been subjected to a specific heat treatment, specifically, the multilayer porous film is heated to a temperature of 170° C. to 190° C., which is higher than the crystal melting peak temperature of the polypropylene resin, and then gradually cooled in order to form and grow β-crystals. This multilayer porous film is analyzed by wide-angle X-ray diffraction. The multilayer porous film is considered to have β-crystal activity when a diffraction peak resulting from the (300)-plane of β-crystals of the polypropylene resin occurs at 2θ=16.0° to 16.5°.

For the details of the β-crystal structure of a polypropylene resin and wide-angle X-ray diffraction, refer to Macromol. Chem. 187, 643-652 (1986), Prog. Polym. Sci. Vol. 16, 361-404 (1991), Macromol. Symp. 89, 499-511 (1995), Macromol. Chem. 75, 134 (1964), and the references cited in the literatures. The details of the method for evaluating β-crystal activity by wide-angle X-ray diffraction are described in Examples below.

The above-described β-crystal activity can be achieved by, for example, not adding a substance that promotes the growth of α-crystals of the polypropylene resin (A) to the resin composition (I), by adding polypropylene in which peroxy radicals have been formed as in Japanese Patent No. 3739481 to the resin composition (I), or by adding a β-phase-nucleating agent to the resin composition (I). Among the above methods, it is particularly preferable to add a β-phase-nucleating agent (D) to the resin composition (I) in order to achieve β-crystal activity. Adding the β-phase-nucleating agent (D) to the resin composition (I) promotes the growth of β-crystals of the polypropylene resin (A) in a more uniform and efficient manner. As a result, a multilayer porous film for batteries which includes a porous layer (layer I) having β-crystal activity can be produced.

1-1-2. βPhase-Nucleating Agent (D)

As described above, in the first invention, the porous layer (layer I) preferably has β-crystal activity and particularly preferably includes the β-phase-nucleating agent (D) in order to form a microporous structure. Examples of the β-phase-nucleating agent (D) used in the first invention include the β-phase-nucleating agents described below. Any β-phase-nucleating agent that promotes the formation and growth of β-crystals of the polypropylene resin (A) may be used. Two or more β-phase-nucleating agents may be used in a mixture.

Examples of the β-phase-nucleating agent (D) include amide compounds; tetraoxaspiro compounds; quinacridones; nanoscale iron oxide; alkali or alkaline-earth metal salts of a carboxylic acid, such as 1,2-hydroxystearic acid potassium salt, magnesium benzoate, magnesium succinate, and magnesium phthalate; aromatic sulfonic acid compounds, such as sodium benzenesulfonate and sodium naphthalenesulfonate; diesters of a dibasic carboxylic acid and triesters of a tribasic carboxylic acid; phthalocyanine pigments, such as phthalocyanine blue; a binary compound constituted by a component A that is an organic dibasic acid and a component B that is an oxide, a hydroxide, or a salt of a metal belonging to the Group II of the periodic table; and a composition containing a cyclic phosphoric acid compound and a magnesium compound.

Specific examples of the β-phase-nucleating agent (D) that is commercially available include a β-phase-nucleating agent “N Jester NU-100” produced by New Japan Chemical Co., Ltd. Specific examples of a polypropylene resin including the β-phase-nucleating agent include a polypropylene “Bepol B-022SP” produced by Aristech, a polypropylene “Beta (β)-PP BE60-7032” produced by Borealis, and a polypropylene “BNX BETAPP-LN” produced by mayzo.

The proportion of the amount of β-phase-nucleating agent (D) added to the polypropylene resin (A) needs to be adjusted appropriately with the type of the β-phase-nucleating agent (D), the composition of the polypropylene resin (A), and the like. The amount of β-phase-nucleating agent (D) added to the polypropylene resin (A) is preferably 0.0001 to 5.0 parts by mass, is more preferably 0.001 to 3.0 parts by mass, and is further preferably 0.01 to 1.0 parts by mass relative to 100 parts by mass of the polypropylene resin (A). When the amount of β-phase-nucleating agent (D) added to the polypropylene resin (A) is 0.0001 parts by mass or more relative to 100 parts by mass of the polypropylene resin (A), it is possible to form and grow β-crystals of the polypropylene resin (A) to a sufficient degree in the production process and to achieve sufficient β-crystal activity, and to maintain the sufficient β-crystal activity even after the multilayer porous film has been formed, which enables the desired air permeability to be achieved. The amount of β-phase-nucleating agent (D) added to the polypropylene resin (A) is preferably 5.0 parts by mass or less relative to 100 parts by mass of the polypropylene resin (A), because this is advantageous from an economical viewpoint and, for example, reduces the occurrence of bleeding of the β-phase-nucleating agent (D) to the film surface.

1-1-3. Other Components

The resin composition (I) constituting the porous layer (layer I) may optionally include various additives, such as a heat stabilizer, an antioxidant, an ultraviolet absorber, a photostabilizer, a colorant, an antistatic agent, an antihydrolysis agent, a lubricant, and a flame retardant, such that the properties of the resin composition (I) are not impaired. The resin composition (I) may also include another resin such that the properties of the resin composition (I) are not impaired. In particular, adding an elastomer to the resin composition (I) enhances air permeability.

1-2. Heat-Resistant Layer (Layer II)

The heat-resistant layer (layer II) included in the multilayer porous film according to the first invention is a layer formed using a resin composition (hereafter, may be referred to as “resin composition (II)”) that includes a polypropylene resin (A), inorganic particles (B), and a specific vinyl aromatic elastomer (C). The heat-resistant layer (layer II) and the resin composition (II) preferably include the polypropylene resin (A), the inorganic particles (B), and the vinyl aromatic elastomer (C) as main components. That is, the total content of the polypropylene resin (A), the inorganic particles (B), and the vinyl aromatic elastomer (C) in the heat-resistant layer (layer II) and the resin composition (II) is preferably 50% by mass or more, is particularly preferably 70% by mass or more, and is more particularly preferably 90% to 100% by mass.

1-2-1. Polypropylene Resin (A)

In the first invention, it is important that the heat-resistant layer (layer II) include the polypropylene resin (A). Adding the polypropylene resin (A) to the layer II enhances the air permeability and heat resistance of the layer II, increases the mechanical strength of the layer II, and improves productivity. Furthermore, in the case where the layer II is brought into direct contact with the porous layer (layer I), the interlaminar adhesion between the layer II and the porous layer (layer I) is increased.

As the polypropylene resin (A) constituting the heat-resistant layer (layer II), the above-described examples of the polypropylene resin (A) constituting the porous layer (layer I) may be used alone or in combination of two or more. Although the polypropylene resin (A) constituting the porous layer (layer I) and the polypropylene resin (A) constituting the heat-resistant layer (layer II) may be the same as or different from each other, they are preferably the same as each other in consideration of, for example, the availability of the materials and the coextrusion formability described below.

1-2-2. Inorganic Particles (B)

In the first invention, it is important that the heat-resistant layer (layer II) include the inorganic particles (B). Adding the inorganic particles (B) to the heat-resistant layer (layer II) enables a heat-resistant layer (layer II) having good air permeability and good dimensional stability to be formed.

Specific examples of the inorganic particles (B) used in the first invention include particles of a metal carbonate, such as calcium carbonate, magnesium carbonate, or barium carbonate; particles of a metal sulfate, such as calcium sulfate, barium sulfate, or magnesium sulfate; particles of a metal oxide, such as calcium oxide, magnesium oxide, zinc oxide, aluminum oxide, silica, or titanium oxide; particles of a metal chloride, such as sodium chloride, magnesium chloride, silver chloride, or calcium chloride; and particles of a clay mineral, such as talc, clay, mica, or montmorillonite. Among the above inorganic particles, particles of a metal oxide are preferable, and particles of an aluminum oxide are particularly preferable, because a battery separator including such inorganic particles is chemically inactive when included in a battery.

The lower limit of the average size of the inorganic particles (B) is preferably 0.01 μm or more, is more preferably 0.1 μm or more, and is further preferably 0.2 μm or more. The upper limit of the average size of the inorganic particles (B) is preferably 3.0 μm or less and is more preferably 1.5 μm or less. It is preferable to set the average size of the inorganic particles (B) to 0.01 μm or more in order to enhance the heat resistance of the multilayer porous film according to the first invention to a sufficient degree. It is preferable to set the average size of the inorganic particles (B) to 3.0 μm or less in order to enhance the dispersibility of the inorganic particles (B).

In this embodiment, the “average size of the inorganic particles (B)” is determined using, for example, a laser diffraction-scattering particle size distribution analyzer.

The specific surface area of the inorganic particles (B) is preferably 1 m²/g or more and less than 30 m²/g. It is preferable to set the specific surface area of the inorganic particles (B) to 1 m²/g or more in order to increase the speed at which an electrolytic solution permeates the multilayer porous film according to the first invention when the multilayer porous film is used as a separator of a lithium-ion secondary battery, which enhances productivity. It is preferable to set the specific surface area of the inorganic particles (B) to be less than 30 m²/g in order to reduce the adsorption of an electrolytic solution component.

1-2-3. Vinyl Aromatic Elastomer (C)

It is important in the first invention that the heat-resistant layer (layer II) include the vinyl aromatic elastomer (C). Adding the vinyl aromatic elastomer (C) to the heat-resistant layer (layer II) enables a highly uniform porous structure to be formed with efficiency and makes it easy to control the shape and size of the pores. As a result, a multilayer porous film having excellent air permeability and excellent ionic permeability can be produced.

The vinyl aromatic elastomer (C) used in the first invention is a thermoplastic elastomer that includes a styrene component as a base material. The vinyl aromatic elastomer (C) is a copolymer including a sequence of a soft component (e.g., a butadiene component) and a hard component (e.g., a styrene component). Examples of the type of the copolymer include, but are not limited to, a random copolymer, a block copolymer, and a graft copolymer. Various types of block copolymer having a linear block structure, a radially branched block structure, and the like are commonly known. The copolymer may have any structure in the first invention.

It is important that the melt flow rate (MFR) of the vinyl aromatic elastomer (C) used in the first invention which is measured at 230° C. with a load of 2.16 kg be 1 g/10 min or less. The shape of domains of the vinyl aromatic elastomer (C) dispersed in the resin composition (II) varies with the difference in viscosity between the vinyl aromatic elastomer (C) and the polypropylene resin (A). When the MFR of the vinyl aromatic elastomer (C) is equal to or lower than the above upper limit, the shape of the domains of the vinyl aromatic elastomer (C) is likely to be spherical. It is preferable that the domains of the vinyl aromatic elastomer (C) have a spherical shape, because a highly uniform porous structure is likely to be formed in such domains during the subsequent stretching step in contrast to the domains having a high aspect ratio and, as a result, the stability of the physical properties of the multilayer porous film may be enhanced. Furthermore, when the MFR of the vinyl aromatic elastomer (C) is equal to or lower than the above upper limit, a stress is likely to concentrate at the interfaces between the matrix having a high elasticity and the domains having a low elasticity in the stretching step. As a result, the origins of the formation of the pores are readily formed. That is, it is easy to form the pores in the film.

From the above viewpoints, the MFR of the vinyl aromatic elastomer (C) is more preferably 0.7 g/10 min or less and is further preferably 0.5 g/10 min or less. Using a vinyl aromatic elastomer (C) having a MFR of 0.5 g/10 min or less further promotes the formation of the pores in the film in the stretching step.

The styrene content in the vinyl aromatic elastomer (C) used in the first invention is preferably 10% to 40% by mass and is more preferably 10% to 35% by mass. Setting the styrene content in the vinyl aromatic elastomer (C) to 10% by mass or more enables effective formation of the domains in the heat-resistant layer (layer II). Setting the styrene content in the vinyl aromatic elastomer (C) to 40% by mass or less suppresses the formation of excessively large domains. In the first invention, the addition of the vinyl aromatic elastomer (C) enables the pores to be communicated with one another and, as a result, reduces the electric resistance of the multilayer porous film.

Specific examples of the type of the vinyl aromatic elastomer (C) include, but are not limited to, a styrene-butadiene block copolymer (SBR), a hydrogenated styrene-butadiene block copolymer (SEB), a styrene-butadiene-styrene block copolymer (SBS), a styrene-butadiene-butylene-styrene block copolymer (SBBS), a styrene-ethylene-butadiene-styrene block copolymer (SEBS), a styrene-isoprene block copolymer (SIR), a styrene-ethylene-propylene block copolymer (SEP), a styrene-isoprene-styrene block copolymer (SIS), a styrene-ethylene-propylene-styrene block copolymer (SEPS), and a styrene-ethylene-ethylene-propylene-styrene block copolymer (SEEPS).

In order to efficiently disperse the vinyl aromatic elastomer (C) in the resin composition (II), among the above vinyl aromatic elastomers (C), a vinyl aromatic elastomer including an ethylene component and a butylene component, which is highly mutually soluble in the polypropylene resin (A), is preferable. In particular, a styrene-ethylene-propylene block copolymer (SEP), a styrene-ethylene-propylene-styrene block copolymer (SEPS), and a styrene-ethylene-butylene-styrene block copolymer (SEBS) are more preferable.

Only one type of vinyl aromatic elastomer (C) may be used. Two or more types of vinyl aromatic elastomers (C) having different compositions or different physical properties may be used in a mixture.

1-2-4. Composition

The amount of vinyl aromatic elastomer (C) is preferably 1 to 30 parts by mass and is more preferably 10 to 20 parts by mass relative to 100 parts by mass of the resin composition (II). Setting the content of the vinyl aromatic elastomer (C) to 1 part by mass or more makes it easy to form pores in the film by stretching and enhances the air permeability of the multilayer porous film. Setting the content of the vinyl aromatic elastomer (C) to 30 parts by mass or less advantageously reduces the coarsening of the porous structure which may occur during stretching and increases the mechanical strength of the multilayer porous film. Furthermore, in such a case, it is possible to fill the heat-resistant layer (layer II) with a sufficient amount of inorganic particles (B), which enhances heat resistance.

The proportions of the amounts of polypropylene resin (A), inorganic particles (B), and vinyl aromatic elastomer (C) included in the heat-resistant layer (layer II) and the resin composition (II) are such that the mixing ratio (A)/(B)/(C) between the amounts of polypropylene resin (A), inorganic particles (B), and vinyl aromatic elastomer (C) is preferably 20% to 60%/20% to 60%/1% to 30% by mass (where (A)+(B)+(C)=100 mass %) and is more preferably 10% to 40%/20% to 60%/10% to 20% by mass (where (A)+(B)+(C)=100 mass %). Setting the proportion of the amount of inorganic particles (B) to 20% by mass or more enhances heat resistance to abnormal heat generation and the safety of the battery. Setting the proportion of the amount of inorganic particles (B) to 60% by mass or less enhances the consistency of the formation of the film and increases the productivity of the multilayer porous film.

Since the heat-resistant layer (layer II) and the resin composition (II) include the polypropylene resin (A), the inorganic particles (B), and the vinyl aromatic elastomer (C), it is possible to form a multilayer porous film having excellent heat resistance, a uniform porous structure, excellent air permeability, and excellent ionic permeability, as a result of the synergistic combination of good properties of the above materials.

In particular, since the heat-resistant layer (layer II) and the resin composition (II) include both inorganic particles (B) and a vinyl aromatic elastomer (C), it is possible to produce a multilayer porous film having both a uniform porous structure and heat resistance, which is difficult to achieve in the case where the inorganic particles (B) or the vinyl aromatic elastomer (C) is used alone.

1-2-5. Other Components

The resin composition (II) constituting the heat-resistant layer (layer II) may include various additives such as a heat stabilizer, an antioxidant, an ultraviolet absorber, a photostabilizer, a crystal-nucleating agent, a colorant, an antistatic agent, an antihydrolysis agent, a lubricant, and a flame retardant, such that the properties of the resin composition (II) are not impaired. The resin composition (II) may also include other resins such that the properties of the resin composition (II) are not impaired.

1-3. Multilayer Structure

The multilayer porous film according to the first invention may have any structure including at least the above two layers, that is, the porous layer (layer I) and the heat-resistant layer (layer II). The multilayer structure of the multilayer porous film which includes the porous layer (layer I) and the heat-resistant layer (layer II) is not limited.

Adding at least one porous layer (layer I) to the multilayer porous film according to the first invention enhances the air permeability and mechanical strength of the multilayer porous film.

Adding at least one heat-resistant layer (layer II) to the multilayer porous film according to the first invention enhances the air permeability and heat resistance of the multilayer porous film and reduces the electric resistance of the multilayer porous film.

Adding at least one layer I and at least one layer II to the multilayer porous film according to the first invention enhances the air permeability of the multilayer porous film, the stability and productivity of the multilayer porous film in the formation of the film, and the ionic permeability of the multilayer porous film and reduces the electric resistance of the multilayer porous film as a result of the synergistic combination of good properties of the above layers and, when the layers I and II are in direct contact with each other, good interlaminar adhesion between the layers I and II.

The multilayer porous film according to the first invention may include a layer (layer III) other than the porous layer (layer I) or the heat-resistant layer (layer II) such that the function of the multilayer porous film is not impaired. Specifically, the multilayer porous film according to the first invention may have a multilayer structure including a strength-retention layer, a heat-resistant layer (i.e., a high-melting-point resin layer), or a shutdown layer (i.e., a low-melting-point resin layer). The number of layers constituting the multilayer structure is selected appropriately and may be two, three, four, five, six, or seven. The multilayer structure is preferably constituted by two or three layers in consideration of productivity and economy.

Examples of the multilayer structure of the multilayer porous film according to the first invention include a two-type two-layer structure including the layer I and the layer II stacked on top of one another in this order and a two-type three-layer structure including the layer I, the layer II, and the layer I or including the layer II, the layer I, and the layer II stacked on top of one another in this order.

The multilayer thickness ratio of the porous layer (layer I) to the heat-resistant layer (layer II) is not limited and may be adjusted appropriately depending on the application and purpose. In the case where the multilayer porous film according to the first invention has the two-type two-layer structure including the layers I and II stacked on top of one another in this order, the thickness ratio (layer I/layer II) which is determined prior to the stretching step of the method for producing the multilayer porous film according to the first invention, which is described below, is preferably 1/(0.1 to 10), is more preferably 1/(0.2 to 5), is further preferably 1/(0.33 to 3), and is particularly preferably 1/(0.5 to 2).

In the case where the multilayer porous film according to the first invention includes the two-type three-layer structure including the layers I, II, and I stacked on top of one another in this order, the above thickness ratio (layer I/layer II/layer I) is preferably (0.1 to 10)/1/(0.1 to 10), is more preferably (0.2 to 5)/1/(0.2 to 5), is further preferably (0.33 to 3)/1/(0.33 to 3), and is particularly preferably (0.5 to 2)/1/(0.5 to 2).

In the case where the multilayer porous film according to the first invention includes the two-type three-layer structure including the layers II, I, and II stacked on top of one another in this order, the above thickness ratio (layer II/layer I/layer II) is preferably (0.1 to 10)/1/(0.1 to 10), is more preferably (0.2 to 5)/1/(0.2 to 5), is further preferably (0.33 to 3)/1/(0.33 to 3), and is particularly preferably (0.5 to 2)/1/(0.5 to 2).

Regardless of the multilayer structure, limiting the proportion of the thickness of the heat-resistant layer (layer II) constituting the multilayer porous film to be within the above range reduces the degree of inconsistencies caused due to the difference in viscosity and enhances the production stability and stretchability of the multilayer porous film.

1-4. Method for Producing Multilayer Porous Film

A method for producing the multilayer porous film according to the first invention is described below. The production method described below is merely an example of a method for producing the multilayer porous film according to the first invention. The multilayer porous film according to the first invention is not limited to a multilayer porous film produced by the production method described below.

The multilayer porous film according to the first invention can be produced by kneading and melt-forming the resin composition (I) including the polypropylene resin (A) and the optional components, such as the β-phase-nucleating agent (D) and the other components described above, which constitutes the porous layer (layer I), and the resin composition (II) that includes the polypropylene resin (A), the inorganic particles (B), the vinyl aromatic elastomer (C), and the other optional components described above, which constitutes the heat-resistant layer (layer II), into a multilayer nonporous film-like material with a extruder or the like at a temperature equal to or higher than the melting point of the polypropylene resin (A) and lower than the decomposition temperature of the polypropylene resin (A) and stretching the multilayer nonporous film-like material to form a stretched film.

It is preferable that the method for producing the multilayer porous film according to the first invention do not include a step in which additives are removed with a solvent in order to form pores in the film. In other words, it is preferable to form the pores in the film by only stretching the film.

1-4-1. Production of Multilayer Nonporous Film-Like Material

A method for producing the multilayer nonporous film-like material is not limited, and publicly known methods may be used. For example, the resin compositions (I) and (II) that have been melted separately in an extruder are coextruded through a T-die, and the resulting film-like material is cooled and solidified with a cast roller. In another case, a film-like material produced by a tubular method may be cut and expanded into a planar shape.

More preferably, the following production method is employed.

In extrusion molding, the extrusion temperature is controlled appropriately depending on the flow characteristics, formability, and the like of the resin compositions (I) and (II). The extrusion temperature is preferably 180° C. to 370° C., is more preferably 180° C. to 300° C., and is further preferably 180° C. to 240° C. It is preferable to set the extrusion temperature to 180° C. or more in order to bring the polypropylene resin (A) into a molten state having a sufficiently low viscosity and thereby enhance the formability of the resin composition and the productivity of the film-like material. Setting the extrusion temperature to 370° C. or less limits the degradation of the resin compositions (I) and (II) and, in turn, a reduction in the mechanical strength of the multilayer porous film used as a battery separator.

The temperature at which cooling and solidification are performed with the cast roller is important in the first invention. It is possible to control the formation and growth of the β-crystals of the polypropylene resin (A) and adjust the proportion of the amount of β-crystals in the multilayer nonporous film-like material by controlling the cooling-solidification temperature. The cooling-solidification temperature of the cast roller is preferably 80° C. to 150° C., is more preferably 90° C. to 140° C., and is further preferably 100° C. to 130° C. It is preferable to set the cooling-solidification temperature to 80° C. or more in order to increase the proportion of the β-crystals in the cooled and solidified multilayer nonporous film-like material to a sufficient degree. It is preferable to set the cooling-solidification temperature to 150° C. or less in order to reduce the likelihood of trouble, such as extruded molten resin adhering to and becoming wound around the cast roller, from occurring and increase the efficiency of the formation of the film.

The proportion of the β-crystals of the polypropylene resin (A) in the unstretched multilayer nonporous film-like material is preferably adjusted to be 40% to 100%, is more preferably adjusted to be 50% to 100%, and is further preferably adjusted to be 60% to 100% by setting the temperature of the cast roller to fall within the above range. Limiting the proportion of the β-crystals of the polypropylene resin (A) in the unstretched multilayer nonporous film-like material to 40% or more makes it easy to form pores in the multilayer nonporous film-like material by stretching in the subsequent step and, as a result, enables the production of a film having good air permeability.

1-4-2. Stretching of Multilayer Nonporous Film-Like Material

For stretching the multilayer nonporous film-like material, roller stretching, rolling, tenter stretching, simultaneous biaxial stretching, and the like may be used. The multilayer nonporous film-like material is uniaxially or biaxially stretched by using one of the above methods or two or more selected from the above methods in combination.

The type of uniaxial stretching may be either longitudinal uniaxial stretching or transverse uniaxial stretching. The type of the biaxial stretching may be either simultaneous biaxial stretching or sequential biaxial stretching. In order to form a multilayer porous film having high air permeability, which is an object of the first invention, it is more preferable to use sequential biaxial stretching, which enables the selection of the stretching conditions in each stretching step and makes it easy to control the porous structure. It is particularly preferable to perform sequential biaxial stretching including a longitudinal stretching step followed by a transverse stretching step. The term “longitudinal stretching” used herein refers to stretching the multilayer nonporous film-like material in the machine direction (MD) of the extrusion of the multilayer nonporous film-like material. The term “transverse stretching” used herein refers to stretching the multilayer nonporous film-like material in the direction (TD) perpendicular to the machine direction.

In the case where sequential biaxial stretching is used, it is necessary to select the stretching temperature appropriately in accordance with the compositions, crystal melting peak temperatures, degrees of crystallinity, and the like of the resin compositions (I) and (II) used. Since sequential biaxial stretching makes it relatively easy to control the porous structure, it is easy to achieve those properties and other physical properties such as mechanical strength and shrinkage in a balanced manner.

The stretching temperature in longitudinal stretching is preferably about 20° C. to 140° C., is more preferably 40° C. to 120° C., and is further preferably 60° C. to 110° C. It is preferable to set the stretching temperature in longitudinal stretching to 20° C. or more in order to reduce the likelihood of the film breaking while being stretched and enables uniform stretching of the film. When the stretching temperature in longitudinal stretching is 140° C. or less, pores can be formed in the film in the following three modes: formation of pores in the polypropylene resin (A); interfacial peeling between the polypropylene resin (A) and the inorganic particles (B); and interfacial peeling between the polypropylene resin (A) and the vinyl aromatic elastomer (C). This enables efficient formation of pores.

The longitudinal stretching factor may be selected appropriately. The stretching factor per axis is preferably 1.1 to 10 times, is more preferably 1.5 to 8.0 times, and is further preferably 1.5 to 5.0 times. When the stretching factor per axis is 1.1 times or more, whitening of the film occurs. This indicates that a sufficient amount of pores have been formed in the film by stretching. Limiting the stretching factor per axis to be 10 times or less enables the production of a sufficiently whitened multilayer porous film while reducing the degree of deformation of the pores.

The transverse stretching temperature is preferably 100° C. to 160° C. and is more preferably 110° C. to 155° C. Setting the transverse stretching temperature to fall within the above range enables the pores formed in the film by longitudinal stretching to be expanded. This increases the porosity of the porous layer and enhances the air permeability of the multilayer porous film to a sufficient degree.

The transverse stretching factor may be selected appropriately, is preferably 1.1 to 10 times, is more preferably 1.5 to 8.0 times, and is further preferably 1.5 to 4.0 times. Stretching the film at the above transverse stretching factor enables a multilayer porous film having sufficient air permeability to be formed without deforming the pores formed by longitudinal stretching.

1-4-3. Heat Treatment

The multilayer porous film prepared in the above-described manner is preferably subjected to a heat treatment in order to improve dimensional stability. In order to improve the dimensional stability of the multilayer porous film with effect, the temperature at which the heat treatment is performed is preferably set to 100° C. or more, is more preferably set to 120° C. or more, and is further preferably set to 140° C. or more. The heat-treatment temperature is preferably 170° C. or less, is more preferably 165° C. or less, and is further preferably 160° C. or less. It is preferable to limit the heat-treatment temperature to be 170° C. or less in order to reduce the likelihood of the polypropylene resin (A) melting in the heat treatment and to maintain the porous structure. The multilayer porous film may be optionally subjected to a relaxation treatment of 1% to 20% in the heat treatment.

The multilayer porous film that has been subjected to the heat treatment is uniformly cooled and then coiled. Hereby, a roll of the multilayer porous film is formed.

1-4-4. Others

The multilayer porous film according to the first invention may be optionally subjected to, subsequent to the heat treatment, a surface treatment, such as a corona treatment, a plasma treatment, printing, coating, or vapor deposition, a perforation treatment, and the like such that the advantageous effects of the first invention are not impaired.

1-5. Physical Properties and Characteristics of Multilayer Porous Film

1-5-1. Thickness

The thickness of the multilayer porous film according to the first invention is preferably less than 100 μm, is more preferably less than 50 μm, and is further preferably less than 40 μm. The lower limit of the thickness of the multilayer porous film is preferably 3 μm or more and is more preferably 5 μm or more. When the thickness of the multilayer porous film is less than 100 μm, the multilayer porous film has a small electric resistance, which makes it possible to produce a storage device having sufficiently high performance. When the thickness of the multilayer porous film is 3 μm or more, an electric insulation property that is substantially required by the multilayer porous film can be achieved. In such a case, for example, the likelihood of a short circuit occurring when a large amount of voltage is applied to a battery is small, that is, the safety of the battery is enhanced.

1-5-2. Degree of Air Permeation

The degree of air permeation of the multilayer porous film according to the first invention which is determined at 25° C. in accordance with JIS P8117 (2009) is preferably 100 sec/100 ml or less. A multilayer porous film having a degree of air permeation of 100 sec/100 ml or less has an excellent electric resistance. The degree of air permeation of the multilayer porous film is more preferably 90 sec/100 ml or less and is further preferably 80 sec/100 ml or less.

The degree of air permeation of the multilayer porous film represents the resistance of the multilayer porous film to the permeation of air in the thickness direction. Specifically, the degree of air permeation of the multilayer porous film is expressed as the time in seconds for 100 ml of air to permeate through the multilayer porous film. The lower the degree of air permeation, the lower the resistance to air permeation. The higher the degree of air permeation, the higher the resistance to air permeation. That is, the lower the degree of air permeation, the higher the degree of communication inside the multilayer porous film in the thickness direction. The higher the degree of air permeation, the lower the degree of communication inside the multilayer porous film in the thickness direction. The term “degree of communication” used herein refers to the degree at which the pores formed in the multilayer porous film are communicated with one another in the thickness direction.

The degree of air permeation of the multilayer porous film is measured by, specifically, the method described in Examples below.

1-5-3. Electric Resistance

The electric resistance of the multilayer porous film according to the first invention in the thickness direction which is determined at 25° C. after the multilayer porous film has been impregnated with a solution containing propylene carbonate and ethyl methyl carbonate at a ratio of 1:1 (v/v) which contains 1 M lithium perchlorate is preferably 0.7 Ω or less, is further preferably 0.65 Ω or less, and is particularly preferably 0.6 Ω or less. The lower limit of the electric resistance of the multilayer porous film in the thickness direction is not limited but is typically 0.01 Ω or more under the constraints of material selection.

When the electric resistance of the multilayer porous film in the thickness direction is 0.7 Ω or less, a battery that includes the multilayer porous film according to the first invention as a battery separator is likely to achieve a large current discharge when the output of the battery is increased. In other words, a battery having excellent performance can be produced. In order to produce a multilayer porous film having such a low electric resistance, it is necessary to increase the degree of communication between the pores and ease of migration of ions by controlling the porous structure. Therefore, the electric resistance of the multilayer porous film is greatly dependent on the air permeability of the multilayer porous film. That is, the smaller the degree of air permeation described above, the lower the electric resistance. However, the degree of air permeation is not always proportional to electric resistance.

In the first invention, the vinyl aromatic elastomer (C), which has a melt flow rate (MFR) of 1 g/10 min or less as determined at 230° C. with a load of 2.16 kg, contributes to the formation of pores that constitute the porous structure of the multilayer porous film and the degree of communication between the pores. As a result, a multilayer porous film having a sufficiently low electric resistance can be produced.

A specific method for measuring the electric resistance of the multilayer porous film is described in Examples below.

2) Multilayer Porous Film According to Second Invention

A multilayer porous film according to an embodiment of the second invention is described below.

2-1. Polypropylene Resin Porous Layer (Layer I)

The multilayer porous film according to the second invention includes a polypropylene resin porous layer (layer i) including a polypropylene resin as a main component. The layer i is formed using a polypropylene resin composition (hereafter, may be referred to as “polypropylene resin composition (i)”). The content of a polypropylene resin in the polypropylene resin composition (i) is normally 80% by mass or more and is preferably 90% by mass or more. The layer i is preferably a layer composed of a polypropylene resin composition (i) including a polypropylene resin (A) and a β-phase-nucleating agent (D) and is a homogeneous porous film formed by stretching due to β-crystal activity.

2-1-1. Polypropylene Resin (A)

The polypropylene resin (A) used in the second invention may be the same as the polypropylene resin (A) used in the first invention. Thus, the description of the first invention in the section “1-1-1. Polypropylene Resin (A)” is directly applicable to the description in the section “2-1-1. Polypropylene Resin (A)”.

Also in the multilayer porous film according to the second invention, the polypropylene resin porous layer (layer i) preferably has β-crystal activity as for the porous layer (layer I) included in the multilayer porous film according to the first invention. Thus, the description of the β-crystal activity of the multilayer porous film according to the first invention is also directly applicable when reading the resin composition (I) as the polypropylene resin composition (i) and the porous layer (layer I) as the polypropylene resin porous layer (layer i).

2-1-2. β-Phase-Nucleating Agent (D)

As in the first invention, the polypropylene resin porous layer (layer i) preferably has β-crystal activity in order to form a microporous structure also in the second invention. It is particularly preferable to use a β-phase-nucleating agent (D). The description of the first invention in the section “1-1-2. β-Phase-Nucleating Agent (D)” is directly applicable to the description of the type of the β-phase-nucleating agent (D) and the proportion of the amount of β-phase-nucleating agent (D) added to the polypropylene resin (A).

2-1-3. Other Components

The polypropylene resin composition (i) constituting the polypropylene resin porous layer (layer i) may optionally include various additives, such as a heat stabilizer, an antioxidant, an ultraviolet absorber, a photostabilizer, a colorant, an antistatic agent, an antihydrolysis agent, a lubricant, and a flame retardant, such that the properties of the polypropylene resin composition (i) are not impaired. The polypropylene resin composition (i) may also include other resins such that the properties of the polypropylene resin composition (i) are not impaired. In particular, adding an elastomer to the polypropylene resin composition (i) enhances air permeability.

2-2. Heat-Resistant Layer (Layer ii)

In the multilayer porous film according to the second invention, the heat-resistant layer (layer ii) is formed using a polypropylene resin composition (hereafter, may be referred to as “polypropylene resin composition (ii)”) that includes a polypropylene resin (A) and inorganic particles (B) as main components at predetermined proportions. The total content of the polypropylene resin (A) and the inorganic particles (B) in the polypropylene resin composition (ii) is preferably 70% by mass or more and is particularly preferably 80% to 100% by mass.

2-2-1. Polypropylene Resin (A)

As the polypropylene resin (A) constituting the heat-resistant layer (layer ii), one or more polypropylene resins selected from the above-described examples of the polypropylene resin (A) constituting the polypropylene resin porous layer (layer i) can be used. The polypropylene resin (A) constituting the polypropylene resin porous layer (layer i) and the polypropylene resin (A) constituting the heat-resistant layer (layer ii) may be the same as or different from each other and are preferably the same as each other in consideration of the availability of the materials and coextrusion formability described below.

2-2-2. Inorganic Particles (B)

In the second invention, it is important that the heat-resistant layer (layer ii) include the inorganic particles (B). Adding the inorganic particles (B) to the heat-resistant layer (layer ii) enhances the air permeability and dimensional stability of the heat-resistant layer (layer ii). In addition, using the heat-resistant layer (layer ii) including the inorganic particles (B) as an outermost layer advantageously increases the surface roughness of the multilayer porous film and the coefficient of kinetic friction of the multilayer porous film.

The inorganic particles (B) used in the second invention may be the same as those used in the first invention. Thus, the description of the first invention in the section “1-2-2. Inorganic Particles (B)” is directly applicable to the description of the section “2-2-2. Inorganic Particles (B)”.

The proportions of the amounts of polypropylene resin (A) and inorganic particles (B) included in the heat-resistant layer (layer ii) are such that the amount of polypropylene resin (A) is 20 to 80 parts by mass and the amount of inorganic particles is 80 to 20 parts by mass (relative to 100 parts by mass of the total amount of polypropylene resin (A) and inorganic particles (B)). Setting the content of the inorganic particles (B) to the above lower limit or more increases the coefficient of kinetic friction of the surface of the layer ii of the multilayer porous film according to the second invention, which reduces the area shrinkage of the multilayer porous film and enhances the safety of a battery. Setting the content of the inorganic particles (B) to be the above upper limit or less enables consistent formation of the film and increases the productivity of the multilayer porous film. The proportions of the amounts of polypropylene resin (A) and inorganic particles (B) are more preferably such that the amount of polypropylene resin (A) is 30 to 70 parts by mass and the amount of inorganic particles is 70 to 30 parts by mass. The proportions of the amounts of polypropylene resin (A) and inorganic particles (B) are further preferably such that the amount of polypropylene resin (A) is 40 to 60 parts by mass and the amount of inorganic particles is 60 to 40 parts by mass (relative to 100 parts by mass of the total amount of polypropylene resin (A) and inorganic particles (B)).

2-2-3. Other Particle Components

The heat-resistant layer (layer ii) may optionally include, in addition to the inorganic particles (B) described above, organic particles that can be formed into a film-like material together with the polypropylene resin (A) by extrusion forming. The organic particles preferably have a crystal melting peak temperature higher than the stretching temperature so as not to be melted at the stretching temperature. The organic particles are further preferably crosslinked organic particles having a gel fraction of about 4% to about 10%. Examples of the organic particles include particles of a thermoplastic resin or a thermosetting resin, such as ultra-high-molecular-weight polyethylene, polystyrene, polymethyl methacrylate, polycarbonate, polyethylene terephthalate, polybutylene terephthalate, polyphenylene sulfide, polysulfone, polyether sulfone, polyether ether ketone, polytetrafluoroethylene, polyimide, polyetherimide, melamine, or benzoguanamine. The above types of organic particles may be used alone or in combination of two or more. The addition of the above organic particles increases the surface roughness of the multilayer porous film according to the second invention and the coefficient of kinetic friction of the multilayer porous film.

In the case where the heat-resistant layer (layer ii) includes the above organic particles, the content of the organic particles in the heat-resistant layer (layer ii) is preferably 20% by mass or less, that is, for example, 1% to 20% by mass.

2-2-4. Other Components

The polypropylene resin composition (ii) constituting the heat-resistant layer (layer ii) may optionally include various additives such as a heat stabilizer, an antioxidant, an ultraviolet absorber, a photostabilizer, a crystal-nucleating agent, a colorant, an antistatic agent, an antihydrolysis agent, a lubricant, and a flame retardant such that the properties of the polypropylene resin composition (ii) are not impaired. The polypropylene resin composition (ii) may also include other resins such that the properties of the polypropylene resin composition (ii) are not impaired. In particular, adding an elastomer to the polypropylene resin composition (ii) enhances air permeability.

In the case where the polypropylene resin composition (ii) includes an elastomer, one or more elastomers selected from, for example, a styrene-butadiene elastomer, a polyolefin elastomer, a urethane elastomer, a polyester elastomer, a polyamide elastomer, a 1,2-polybutadiene elastomer, a polyvinyl chloride elastomer, and an ionomer can be used such that the content of the elastomers in the polypropylene resin composition (ii) is 20% by mass or less, that is, for example, 1% to 20% by mass.

2-3. Multilayer Structure

The multilayer porous film according to the second invention includes at least three layers that are one polypropylene resin porous layer (layer i) and two heat-resistant layers (layers ii) stacked on top of one another in the order of the layer ii, the layer i, and the layer ii.

In the case where the multilayer porous film according to the second invention is used as a battery separator, the heat-resistant layers (layers ii), between which the polypropylene resin porous layer (layer i) is interposed, reduce the shrinkage of the separator which occurs due to abnormal heat generation in the battery and, as a result, enhances the safety of the battery.

Furthermore, the polypropylene resin porous layer (layer i) interposed between the heat-resistant layers (layers ii) enables the multilayer porous film according to the second invention to maintain high air permeability and a high mechanical strength.

Since the polypropylene resin porous layer (layer i) and the heat-resistant layers (layers ii) are both primarily composed of a polypropylene resin that is a thermoplastic resin, a high interlaminar adhesion between the layers i and ii can be achieved when they are in direct contact with each other. In addition, it becomes possible to form the layers i and ii in a multilayer form by coextrusion in the production of the multilayer porous film according to the second invention. This increases the productivity of the multilayer porous film.

The multilayer thickness ratio of the polypropylene resin porous layer (layer i) to the heat-resistant layers (layers ii) is not limited. The multilayer thickness ratio layer ii/layer i/layer ii determined prior to the stretching step of the method for producing the multilayer porous film according to the second invention, which is described below, is preferably (1 to 4)/(30 to 1)/(1 to 4), is more preferably (1 to 2)/(20 to 1)/(1 to 2), is further preferably 1/(20 to 1)/1, and is particularly preferably 1/(20 to 2)/1. Setting the thickness ratio between the layers i and ii to fall within the above range reduces the degree of inconsistencies caused due to the difference in viscosity. Setting the thickness of the layer i to be larger than that of the layers ii enhances the mechanical properties of the multilayer porous film to a sufficient level required by a battery separator.

The multilayer porous film according to the second invention may have any structure including the layer ii, the layer i, and the layer ii stacked on top of one another in this order. The multilayer porous film may optionally include a layer constituted by another resin which is interposed between the layers i and ii or disposed on the surface of the layer i or ii such that the advantageous effects of the second invention are not impaired. In the second invention, it is preferable that at least one or preferably both of the heat-resistant layers (layers ii) serve as outermost layers of the multilayer porous film, because, when the multilayer porous film has a multilayer structure including the layer ii, the layer i, and the layer ii stacked on top of one another in this order and the heat-resistant layers (layers ii) serve as outermost layers of the multilayer porous film, the coefficient of kinetic friction of the multilayer porous film on an electrode material is increased, which reduces the shrinkage of the separator which occurs due to abnormal heat generation in the lithium-ion secondary battery and enhances the safety of the battery with certainty.

2-4. Method for Producing Multilayer Porous Film

A method for producing the multilayer porous film according to the second invention is described below. The production method described below is merely an example of a method for producing the multilayer porous film according to the second invention. The multilayer porous film according to the second invention is not limited to a multilayer porous film produced by the production method described below.

The multilayer porous film according to the second invention can be produced by kneading and melt-forming the polypropylene resin composition (i) including the polypropylene resin (A) and the optional components, such as the β-phase-nucleating agent (D) and the other components described above, which constitutes the polypropylene resin porous layer (layer i), and the polypropylene resin composition (ii) that includes the polypropylene resin (A), the inorganic particles (B), and the other optional components described above, which constitutes the heat-resistant layer (layer ii), into a multilayer nonporous film-like material with a extruder or the like at a temperature equal to or higher than the melting point of the polypropylene resin (A) and lower than the decomposition temperature of the polypropylene resin (A) and stretching the multilayer nonporous film-like material to form a stretched film.

It is preferable that the method for producing the multilayer porous film according to the second invention do not include a step in which additives are removed with a solvent in order to form pores in the film. In other words, it is preferable to form the pores in the film by only stretching the film.

2-4-1. Production of Multilayer Nonporous Film-Like Material

The multilayer nonporous film-like material may be produced as in the production of the multilayer nonporous film-like material according to the first invention. Thus, the description of the first invention in the section “1-4-1. Production of Multilayer Nonporous Film-Like Material” is directly applicable when reading the resin composition (I) and the resin composition (II) in the first invention as the polypropylene resin composition (i) and the polypropylene resin composition (ii), respectively, in the second invention.

2-4-2. Stretching of Multilayer Nonporous Film-Like Material

The multilayer nonporous film-like material is stretched as in the stretching of the multilayer nonporous film-like material in the first invention. Thus, the description of the first invention in the section “1-4-2. Stretching of Multilayer Nonporous Film-Like Material” is directly applicable when reading the resin composition (I) and the resin composition (II) in the first invention as the polypropylene resin composition (i) and the polypropylene resin composition (ii), respectively, in the second invention.

When the stretching temperature in longitudinal stretching in the second invention is 130° C. or less, pores can be formed in the film in the following two modes: formation of pores in the polypropylene resin (A); and interfacial peeling between the polypropylene resin (A) and the inorganic particles (B). This enables efficient formation of the pores.

2-4-3. Heat Treatment

As in the first invention, the multilayer porous film prepared in the above-described manner is preferably subjected to a heat treatment in order to improve dimensional stability. The description of the first invention in the section “1-4-3. Heat Treatment” is directly applicable to the description of the heat treatment.

2-5. Physical Properties and Characteristics of Multilayer Porous Film

2-5-1. Coefficient of Kinetic Friction

In the multilayer porous film according to the second invention, the coefficient of kinetic friction of the surface of the layer ii on a polyethylene terephthalate (PET) film having an arithmetic average surface roughness Ra of 0.3 μm or less which is determined in accordance with JIS K7125 (1999) is 0.6 or more and is more preferably 0.7 or more. When the coefficient of kinetic friction of the surface of the layer ii on the PET film is 0.6 or more, using the multilayer porous film as a battery separator reduces the amount of shrinkage of the separator which occurs as a result of abnormal heat generation in the lithium-ion secondary battery and enhances the safety of the battery. It is possible in the second invention to readily achieve such a coefficient of kinetic friction by, for example, stretching the heat-resistant layer (layer ii) including the inorganic particles (B), which serves as an outermost layer, under the above-described conditions in the formation of the film. The upper limit of the coefficient of kinetic friction of the surface of the multilayer porous film according to the second invention is preferably 3.0 or less, is more preferably 2.0 or less, and is further preferably 1.0 or less in consideration of productivity in the formation of the film.

The arithmetic average roughness Ra of the PET film used in the measurement of coefficient of kinetic friction is determined in accordance with JIS B0601 (2013) with, for example, a noncontact three-dimensional surface roughness tester. The lower limit of the Ra of the PET film is normally, but not limited to, 0.01 μm or more under the constraints of production.

The coefficient of kinetic friction of the surface of the multilayer porous film is measured by, specifically, the method described in Examples below.

2-5-2. Area Shrinkage

The area shrinkage of the multilayer porous film according to the second invention which occurs when the temperature of the multilayer porous film is increased from 40° C. to 200° C. at 16 ° C./min is preferably 10% or less, is more preferably 7% or less, and is further preferably 5% or less. In the case where a multilayer porous film having an area shrinkage of 10% or less is used as a battery separator, even when an anomaly occurs in the battery and the battery runs into thermal runaway, the separator is resistant to breakage or shrinkage, capable of maintaining an insulation property, and prevents the occurrence of a short circuit between the electrodes with certainty in order to reduce the occurrence of an accident caused by abnormal heat generation in the battery, such as ignition. The above temperature “200° C.”, which corresponds to the temperature of abnormal heat generation in the battery, corresponds to the temperature at which the abnormal heat generation in common batteries occurs.

The area shrinkage of the multilayer porous film is measured by, specifically, the method described in Examples below.

2-5-3. Thickness

The thickness of the multilayer porous film according to the second invention is preferably less than 100 μm, is more preferably less than 50 μm, and is further preferably less than 40 μm. The lower limit of the thickness of the multilayer porous film is preferably 3 μm or more and is more preferably 5 μm or more. When the thickness of the multilayer porous film is less than 100 μm, the electric resistance of the multilayer porous film is small and it becomes possible to produce a storage device having sufficiently high performance. When the thickness of the multilayer porous film is 3 μm or more, an electric insulation property that is substantially required by the multilayer porous film can be achieved. In such a case, for example, the likelihood of a short circuit occurring when a large amount of voltage is applied to a battery is small, that is, the safety of the battery is enhanced.

2-5-4. Degree of Air Permeation

The degree of air permeation of the multilayer porous film according to the second invention which is determined at 25° C. is preferably 300 sec/100 ml or less, is more preferably 200 sec/100 ml or less, and is further preferably 100 sec/100 ml or less. When the degree of air permeation of the multilayer porous film at 25° C. is 300 sec/100 ml or less, the multilayer porous film has an excellent electric resistance.

The description of the first invention in the section “1-5-2. Degree of Air Permeation” is applicable to the degree of air permeation of the multilayer porous film according to the second invention.

3) Battery Separators and Batteries According to First and Second Inventions

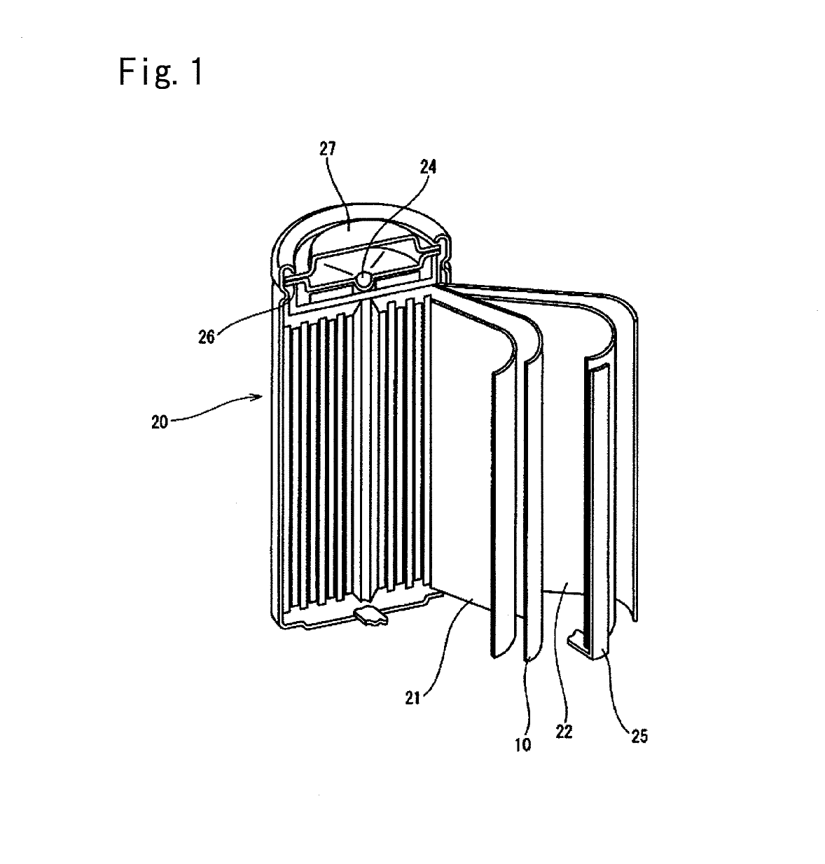

A lithium-ion secondary battery that includes a battery separator that is the multilayer porous film according to the first or second invention is described below with reference to FIG. 1.

Both electrodes, that is, a positive electrode plate 21 and a negative electrode plate 22, are superimposed on each other with a battery separator 10 interposed therebetween and wound in a spiral form. The outer side of the resulting wound body is taped with a binding tape.

The wound body constituted by the positive electrode plate 21, the battery separator 10, and the negative electrode plate 22 that are integrally wound is charged into a closed-end cylindrical battery case and connected to a positive electrode lead 24 and a negative electrode lead 25 by welding. Subsequently, the electrolytic solution described below is charged into the battery case. After the electrolytic solution has sufficiently permeated the battery separator 10 and the like, the battery case is sealed with a positive electrode lid 27 such that a gasket 26 is interposed between the positive electrode lid 27 and the peripheral portions of the opening of the battery case. Then, precharging and aging are performed. Hereby, a cylindrical lithium-ion secondary battery 20 is prepared.

The electrolytic solution is prepared by dissolving a lithium salt used as an electrolyte in an organic solvent. Examples of the organic solvent include, but are not limited to, esters, such as propylene carbonate, ethylene carbonate, butylene carbonate, γ-butyrolactone, γ-balerolactone, dimethyl carbonate, methyl propionate, and butyl acetate; nitriles, such as acetonitrile; ethers, such as 1,2-dimethoxyethane, 1,2-dimethoxymethane, dimethoxypropane, 1,3-dioxolane, tetrahydrofuran, 2-methyltetrahydrofuran, and 4-methyl-1,3-dioxolane; and sulfolane. The above organic solvents may be used alone or in a mixture of two or more.

The negative electrode may be formed by integrating an alkali metal or a compound containing an alkali metal with a current-collecting material such as a stainless steel net. Examples of the alkali metal include lithium, sodium, and potassium. Examples of the compound containing an alkali metal include an alloy of an alkali metal with aluminum, lead, indium, potassium, cadmium, tin, magnesium, or the like; a compound containing an alkali metal and a carbon material; a compound containing a low-potential alkali metal and a metal oxide; and a compound containing a low-potential alkali metal and a sulfide.

When the negative electrode includes a carbon material, any carbon material capable of being doped and dedoped with lithium ions may be used. Examples of such a carbon material include graphite, pyrolytic carbons, cokes, glassy carbons, a substance produced by firing an organic high-molecular-weight compound, mesocarbon microbeads, carbon fibers, and active carbon.

Examples of the active material included in the positive electrode include metal oxides, such as lithium cobalt oxide, lithium nickel oxide, lithium manganese oxide, manganese dioxide, vanadium pentoxide, and chromium oxide; and metal sulfides, such as molybdenum disulfide. For forming the positive electrode, the above positive electrode active material is mixed with a conductant agent, a binder such as polytetrafluoroethylene, and the like as needed, and the resulting mixture is formed into a compact with a core being a current-collecting material, such as a stainless steel net.

### EXAMPLES

The multilayer porous films according to the first and second inventions are described more in detail with reference to Examples and Comparative examples below. However, the present invention is not limited by Examples below.

[Evaluation and Measurement Methods]

<Differential Scanning calorimetry (DSC)>

The multilayer porous film was heated from 25° C. to 240° C. at a scanning rate of 10 ° C./min with a differential scanning calorimeter (DSC-7) produced by PerkinElmer and then held for 1 minute. The multilayer porous film was subsequently cooled from 240° C. to 25° C. at a scanning rate of 10 ° C./min and then held for 1 minute. The multilayer porous film was again heated from 25° C. to 240° C. at a scanning rate of 10 ° C./min. The presence of β-crystal activity was evaluated by determining whether or not, during the reheating period, a peak was detected at 145° C. to 160° C., which is the crystal melting peak temperature (Tmβ) resulting from β-crystals of a polypropylene resin. Evaluation was made on the basis of the following criteria.

◯: Tmβ was detected at 145° C. to 160° C. (β-crystal activity was present)

×: Tmβ was not detected at 145° C. to 160° C. (β-crystal activity was absent)

The measurement of β-crystal activity was conducted using 10 mg of sample in a nitrogen atmosphere.

<Wide-Angle X-Ray Diffraction Analysis (XRD)>

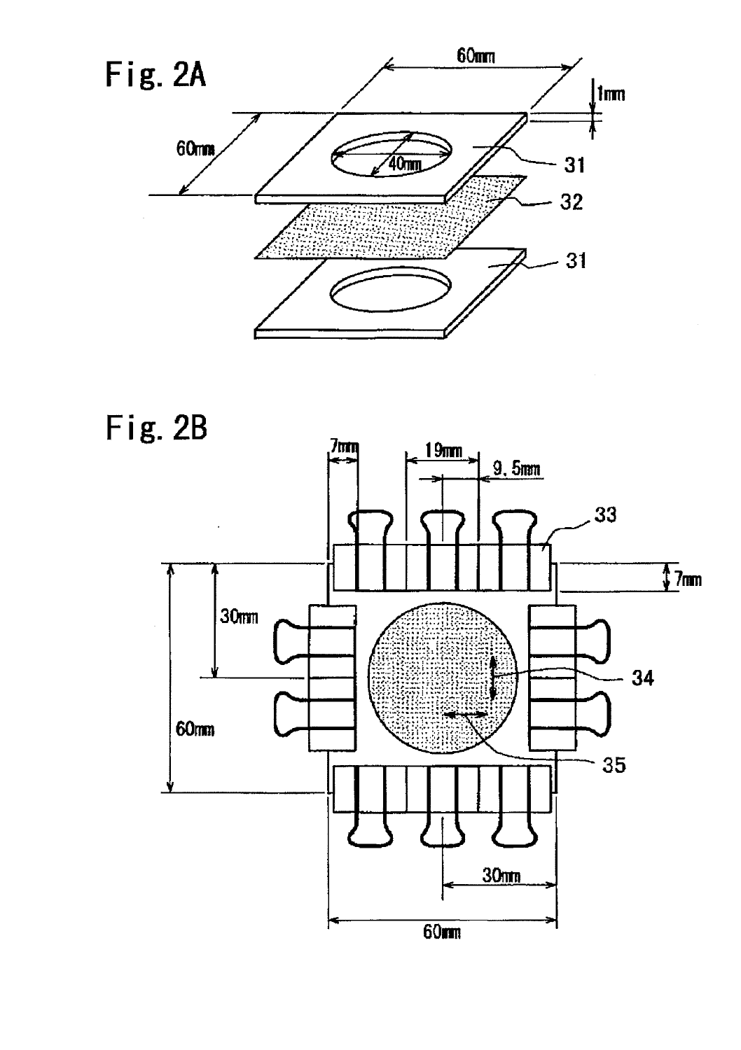

A sample 32 prepared by cutting the multilayer porous film into a 60 mm×60 mm square shape was interposed between two aluminum plates (quality: JIS A5052, size: 60 mm×60 mm, thickness: 1 mm) 31 and 31 each having a 40-mm-diameter circular hole formed at the center as illustrated in FIG. 2A. The peripheral portions of the aluminum plates were pinched with clips 33 as illustrated in FIG. 2B.

The sample 32 of the multilayer porous film, while being bound between the two aluminum plates 31 and 31, was placed in a forced-air-circulation constant-temperature thermostat (produced by Yamato Scientific Co., Ltd., Model: DKN602, preset temperature: 180° C., display temperature: 180° C.) and held for 3 minutes. Subsequently, the preset temperature was changed to 100° C., and the temperature was gradually reduced to 100° C. over 10 minutes or more. When the display temperature reached 100° C., the sample was removed from the thermostat. Then, the sample 32 bound between the two aluminum plates 31 and 31 was cooled for 5 minutes in an atmosphere of 25° C. The central 40-mm-diameter circular portion of the sample was analyzed by wide-angle X-ray diffraction under the following conditions. In FIG. 2B, 34 represents the longitudinal direction of the film, and 35 represents the transverse direction of the film.

Wide-angle X-ray diffraction analyzer: Produced by Mac Science Co., Ltd., Model: XMP18A

X-ray source: CuKα radiation, output: 40 kV, 200 mA

Scanning method: 2θ/θ scanning
2θ range: 5° to 25°
Scanning interval: 0.05°
Scanning rate: 5 °/min

The presence of β-crystal activity was evaluated as follows on the basis of the peak resulting from the (300)-plane of β-crystals of a polypropylene resin which may occur in the resulting diffraction profile.

◯: The peak was detected at 2θ=16.0° to 16.5° (β-crystal activity was present)

×: The peak was not detected at 2θ=16.0° to 16.5° (β-crystal activity was absent)

<Thickness>

The thickness of the multilayer porous film was determined by measuring the thickness of the multilayer porous film with a 1/1000-mm dial gauge at 10 positions randomly selected within the surface of the multilayer porous film and taking the average thereof.

<Degree of Air Permeation (Gurley Permeability)>

The degree of air permeation of the multilayer porous film was measured in an air atmosphere of 25° C. in accordance with JIS P8117 (2009) with a Digital Oken-type Air Permeability Tester (produced by Asahi Seiko Co., Ltd.).

<Electric Resistance>

In an air atmosphere of 25° C., the multilayer porous film was cut into a 3.5 cm×3.5 cm square piece, the piece was a placed in a glass petri dish, a solution containing propylene carbonate and ethyl methyl carbonate at proportions of 1:1 (v/v) which contained 1 M lithium perchlorate (produced by KISHIDA CHEMICAL Co., Ltd.), which served as an electrolytic solution, was charged into the petri dish such that the multilayer porous film was soaked in the solution in order to impregnate the multilayer porous film with the electrolytic solution. Subsequently, the multilayer porous film was removed from the solution, and excess electrolytic solution was wiped out. The multilayer porous film was placed on a stainless steel petri dish having a diameter of 60 mm. A 100-gram cylindrical stainless steel weight having a bottom diameter of 30 mm was slowly placed on the multilayer porous film. With terminals being connected to the petri dish and the weight, the electric resistance of the multilayer porous film was measured using a HIOKI LCR HiTESTER (produced by Hioki E.E. Corporation, model: 3522-50). The electric resistance of the multilayer porous film was evaluated in the following manner.

◯: The electric resistance of the multilayer porous film was 0.7 Ω or less.

×: The electric resistance of the multilayer porous film was more than 0.7 Ω.

<Evaluation of Area Shrinkage (Heat Resistance)>

A waterproof abrasive paper #1000 (produced by Riken Corundum Co., Ltd.) which had been cut into a 115 mm×140 mm size was placed on a hot plate (ND-2 produced by AS ONE Corporation) heated at 40° C. such that the abrasive surface of the abrasive paper faced upward. On the abrasive paper, the multilayer porous film that had been cut into a 50 mm×50 mm square shape was superimposed such that air was not trapped therebetween. On the multilayer porous film, a PET film (Diafoil S100-50 produced by Mitsubishi Plastics, Inc., thickness: 50 μm, surface Ra: 0.22 μm) that had been cut into a 200 mm×200 mm square shape and heated at 180° C. for 1 hour was stacked. On the PET film, two heat-resistant glass sheets (produced by TOSHIN RIKO CO., LTD.) having a 200 mm×200 mm×5 mm size were stacked. Subsequently, the preset temperature of the hot plate was set to 200° C. and the temperature was increased to 200° C. at 16 ° C./min. After the temperature had reached 200° C., the temperature was reduced to normal temperature. Then, the multilayer porous film was removed.

The weight (hereafter, referred to as “W₁”) of a PET film (Diafoil S100-50 produced by Mitsubishi Plastics, Inc.) that had been cut into a 50 mm×50 mm square shape was measured. This PET film was superimposed on the sample, and the shape of the shrunken sample was copied onto the PET film. The PET film was cut into a piece along the shape, and the weight (hereafter, referred to as “W₂”) of the piece of the PET film was measured. The area shrinkage of the multilayer porous film was calculated using the following formula.

Area shrinkage (%)={1−(W₂/W₁)}×100

When the area shrinkage of the multilayer porous film which occurs when the multilayer porous film has been heated to 200° C. is small, using the multilayer porous film as a component of a battery reduces the misalignment and the shrinkage and prevents a short circuit from occurring as a result of abnormal heat generation. The area shrinkage of the multilayer porous film was evaluated in the following manner.

◯: The area shrinkage of the multilayer porous film which occurred when the multilayer porous film was heated to 200° C. was 10% or less.

×: The area shrinkage of the multilayer porous film which occurred when the multilayer porous film was heated to 200° C. was more than 10%.

<Coefficient of Kinetic Friction>

The measurement of the coefficient of kinetic friction was conducted in accordance with JIS K7125 (1999) by superimposing the surface of a PET film (Diafoil S100-50 produced by Mitsubishi Plastics, Inc., thickness: 50 μm, surface Ra: 0.22 μm) on the layer-ii-side surface of the multilayer porous film. Evaluation was made on the basis of the following criteria.

◯: The coefficient of kinetic friction was 0.6 or more.

×: The coefficient of kinetic friction was less than 0.6.

[Raw Materials for Production of Film]

### <Polypropylene Resin (A)>

A-1; Polypropylene (NOVATEC FY6HA, produced by Japan Polypropylene Corporation, MFR: 2.4 g/10 min, Mw/Mn: 3.2)

<Inorganic Particles (B)>
B-1; Alumina (LS235C, produced by Nippon Light Metal Holdings Co., Ltd., average particle size: 0.53 μm, specific surface area: 6.4 m²/g)
B-2; Alumina (LS710A, produced by Nippon Light Metal Holdings Co., Ltd., average particle size: 0.50 μm, specific surface area: 6.9 m²/g)

<Vinyl Aromatic Elastomer (C)>
C-1; Styrene-ethylene-propylene block copolymer (grade name; SEPTON1001, styrene content: 35 mass %, MFR: 0.1 g/10 min, produced by Kuraray Co., Ltd.)
C-2; Styrene-ethylene-propylene-styrene block copolymer (grade name: SEPTON2007, styrene content: 30 mass %, MFR: 2.7 g/10 min, produced by Kuraray Co., Ltd.)

<β-Phase-Nucleating Agent (D)>
D-1; 3,9-Bis[4-(N-cyclohexylcarbamoyl)phenyl]-2,4,8,10-tetraoxaspiro[5.5]undecane

1) Examples and Comparative Examples of First Invention

### Example 1

To 100 parts by mass of the polypropylene resin (A-1), the β-phase-nucleating agent (D-1) was added in the specific amount shown in Table 1. The above components were charged into a twin-screw extruder. After the temperature of the extruder had been set to 240° C., the components were melt-mixed. The resulting strand was cooled and solidified in a water tank and then cut with a pelletizer into pellets (hereafter, referred to as “pellets (I)”) of a resin composition (I), which was used for forming a porous layer (layer I) including a polypropylene resin. Similarly, pellets (hereafter, referred to as “pellets (II)”) of a resin composition (II), which was used for forming a heat-resistant layer (layer II), were prepared using the polypropylene resin (A-1), the inorganic particles (B-1), and the vinyl aromatic elastomer (C-1) in the specific amounts shown in Table 1.

The pellets (I) and (II) were melt-mixed at 200° C. with a uniaxial extruder. Subsequently, the pellets (I) including the polypropylene resin (A-1) and the β-phase-nucleating agent (D-1) were charged into an outer-layer-side extruder, and the pellets (II) including the polypropylene resin (A-1), the inorganic particles (B-1), and the vinyl aromatic elastomer (C-1) were charged into an inner-layer-side extruder. The pellets (I) and (II) were coextruded through a T-die having a lip opening of 1 mm at an extrusion temperature of 200° C., and the resulting film was introduced to a cast roller having a temperature of 127° C. Hereby, a multilayer nonporous film-like material was prepared. The multilayer nonporous film-like material was stretched in the longitudinal direction at a stretching factor of 4.5 times using a longitudinal stretching machine with rollers heated at 105° C. The longitudinally stretched film was preheated with a film tenter facility (produced by Kyoto Machinery Co., Ltd.) at a preheating temperature of 145° C. for a preheating time of 12 seconds, stretched in the transverse direction at a stretching factor of 2.0 times at a stretching temperature of 145° C., and then heated at 155° C. Hereby, a multilayer porous film was formed. Table 1 summarizes the evaluation results of the multilayer porous film.

### Example 2

The pellets (I) used for forming the porous layer (layer I) and the pellets (II) used for forming the heat-resistant layer (layer II) were prepared as in Example 1 using the specific amounts of materials described in Table 1.

The pellets (I) and (II) were formed into a multilayer nonporous film-like material as in Example 1. The multilayer nonporous film-like material was then subjected to longitudinal stretching, transverse stretching, and a heat treatment as in Example 1. Table 1 summarizes the evaluation results of the multilayer porous film.

### Examples 3 to 5

The pellets (I) used for forming the porous layer (layer I) and the pellets (II) used for forming the heat-resistant layer (layer II) were prepared as in Example 1 using the specific amounts of materials described in Table 1.

The pellets (I) were charged into an inner-layer-side extruder, and the pellets (II) were charged into an outer-layer-side extruder. The pellets (I) and (II) were formed into a multilayer nonporous film-like material. The multilayer nonporous film-like material was then subjected to longitudinal stretching, transverse stretching, and a heat treatment as in Example 1, except that the transverse stretching factor was changed to 3.0 times in Examples 3 and 4. Table 1 summarizes the evaluation results of the multilayer porous film.

### Comparative Example 1

The pellets (I) used for forming the porous layer (layer I) were prepared as in Example 1 using the specific amounts of materials described in Table 1.

The pellets (I) were charged into an inner-layer-side extruder and an outer-layer-side extruder and formed into a single-layer nonporous film-like material as in Example 1. The single-layer nonporous film-like material was then subjected to longitudinal stretching, transverse stretching, and a heat treatment as in Example 1. Table 1 summarizes the evaluation results of the single-layer porous film.

### Comparative Example 2

The pellets (I) used for forming the porous layer (layer I) and pellets (II) used for forming the heat-resistant layer (layer II) which included the polypropylene resin (A-1) and the inorganic particles (B-1) but did not include the vinyl aromatic elastomer (C-1) were prepared as in Example 1 using the specific amounts of materials described in Table 1.

The pellets (I) and (II) were formed into a multilayer nonporous film-like material as in Example 1. The multilayer nonporous film-like material was then subjected to longitudinal stretching, transverse stretching, and a heat treatment as in Example 1. Table 1 summarizes the evaluation results of the multilayer porous film.

### Comparative Example 3

The pellets (I) used for forming the porous layer (layer I) and pellets (II) used for forming the heat-resistant layer (layer II) which included the polypropylene resin (A-1) and the inorganic particles (B-1) but did not include the vinyl aromatic elastomer (C-1) were prepared as in Example 1 using the specific amounts of materials described in Table 1.

The pellets (I) were charged into an inner-layer-side extruder, and the pellets (II) were charged into an outer-layer-side extruder. The pellets (I) and (II) were formed into a multilayer nonporous film-like material as in Example 1. The multilayer nonporous film-like material was then subjected to longitudinal stretching, transverse stretching, and a heat treatment as in Example 1. Table 1 summarizes the evaluation results of the multilayer porous film.

### Comparative Example 4

The pellets (I) used for forming the porous layer (layer I) and pellets (II) used for forming the heat-resistant layer (layer II) which included the polypropylene resin (A-1), the inorganic particles (B-1), and the vinyl aromatic elastomer (C-2) were prepared as in Example 1 using the specific amounts of materials described in Table 1.

The pellets (I) and (II) were formed into a multilayer nonporous film-like material as in Example 1. The multilayer nonporous film-like material was then subjected to longitudinal stretching, transverse stretching, and a heat treatment as in Example 1. Table 1 summarizes the evaluation results of the multilayer porous film.

TABLE 1

| | | Examples | | | | | Comparative examples | | | |
|---|---|---|---|---|---|---|---|---|---|---|
| | | 1 | 2 | 3 | 4 | 5 | 1 | 2 | 3 | 4 |
| Layer I | A-1 | 100 | 100 | 100 | 100 | 100 | 100 | 100 | 100 | 100 |
| (mass parts) | D-1 | 0.2 | 0.2 | 0.2 | 0.2 | 0.2 | 0.2 | 0.2 | 0.2 | 0.2 |
| Layer II | A-1 | 30 | 40 | 40 | 40 | 40 | 100 | 50 | 50 | 40 |
| (mass parts) | D-1 | | | | | | 0.2 | | | |
| | B-1 | 50 | 50 | 50 | 50 | | | 50 | 50 | 50 |
| | B-2 | | | | | 50 | | | | |
| | C-1 | 20 | 10 | 10 | 10 | 10 | | | | |
| | C-2 | | | | | | | | | 10 |
| Multilayer thickness ratio before | | 1/1/1 | 1/1/1 | — | — | — | Single | 1/1/1 | — | 1/1/1 |
| stretching [layer I/layer II/layer I] | | | | | | | layer | | | |
| Multilayer thickness ratio before | | — | — | 1/3/1 | 2/1/2 | 1/1/1 | | — | 1/1/1 | — |
| stretching [layer II/layerI/layer II] | | | | | | | | | | |
| Thickness | μm | 25 | 29 | 34 | 24 | 29 | 28 | 29 | 35 | 29 |
| Degree of air permeation | sec/100 ml | 62 | 70 | 83 | 27 | 48 | 150 | 102 | 61 | 98 |
| β-Crystal activity | — | ◯ | ◯ | ◯ | ◯ | ◯ | ◯ | ◯ | ◯ | ◯ |
| (DSC) | | | | | | | | | | |
| β-Crystal activity | — | ◯ | ◯ | ◯ | ◯ | ◯ | ◯ | ◯ | ◯ | ◯ |
| (XRD) | | | | | | | | | | |
| Electric resistance | Ω | 0.55 | 0.56 | 0.57 | 0.39 | 0.49 | 0.71 | 0.72 | 1.03 | 0.91 |
| | Evaluation | ◯ | ◯ | ◯ | ◯ | ◯ | X | X | X | X |

As is clear from the results obtained in Examples 1 to 5, the multilayer porous films constituted by the porous layer (layer I) including the polypropylene resin (A) as a main component and by the heat-resistant layer (layer II) including the polypropylene resin (A), the inorganic particles (B), and the vinyl aromatic elastomer (C) having a melt flow rate (MFR) of 1 g/10 min or less as determined at 230° C. with a load of 2.16 kg had excellent air permeability and a good electric resistance regardless of the multilayer ratio between (layer I) and (layer II) or the amount of vinyl aromatic elastomer (C) used.

In the single-layer porous film prepared in Comparative example 1, which was constituted by only the polypropylene resin porous layer (layer I) and did not include the inorganic particles (B) and the vinyl aromatic elastomer (C), formation of pores as a result of the addition of the inorganic particles (B) and the vinyl aromatic elastomer (C) did not occur. Consequently, the degree of air permeation of the single-layer porous film was high, and the electric resistance of the single-layer porous film was also high.

In the multilayer porous films prepared in Comparative examples 2 and 3, where the heat-resistant layer (layer II) included in the multilayer porous film did not include the vinyl aromatic elastomer (C), the contribution of the addition of the vinyl aromatic elastomer (C) to the formation of pores in the stretching step was not made. Consequently, the degree of communication between the pores was low, and it was not possible to reduce the electric resistance of the multilayer porous film.

In the multilayer porous film prepared in Comparative example 4, where the vinyl aromatic elastomer included in the heat-resistant layer (layer II) of the multilayer porous film had a melt flow rate (MFR) of 1 g/10 min or more as determined at 230° C. with a load of 2.16 kg, a stress did not concentrate at the matrix-domain interfaces and the formation of pores did not start at the matrix-domain interfaces. Consequently, the multilayer porous film did not have a sufficiently low electric resistance.

2) Examples and Comparative Examples of Second Invention

### Example 6

To 100 parts by mass of the polypropylene resin (A-1), the β-phase-nucleating agent (D-1) was added in the specific amount shown in Table 2. The above components were charged into a twin-screw extruder. After the temperature of the extruder had been set to 240° C., the components were melt-mixed. The resulting strand was cooled and solidified in a water tank and then cut with a pelletizer into pellets (hereafter, referred to as “pellets (i)”) of a polypropylene resin composition (i), which was used for forming a polypropylene resin porous layer (layer i). Similarly, pellets (hereafter, referred to as “pellets (ii)”) of a polypropylene resin composition (ii), which was used for forming a heat-resistant layer (layer ii) that includes a polypropylene resin and inorganic particles, were prepared using the polypropylene resin (A-1) and the inorganic particles (B-1) in the specific amounts shown in Table 2.

The pellets (I) and (II) were melt-mixed at 200° C. with a uniaxial extruder. Subsequently, the pellets (ii) including the polypropylene resin (A-1) and the inorganic particles (B-1) were charged into an outer-layer-side extruder, and the pellets (i) including the polypropylene resin (A-1) and the β-phase-nucleating agent (D-1) were charged into an inner-layer-side extruder. The pellets (i) and (ii) were coextruded through a T-die having a lip opening of 1 mm at an extrusion temperature of 200° C., and the resulting film was introduced to a cast roller having a temperature of 127° C. Hereby, a multilayer nonporous film-like material was prepared. The multilayer nonporous film-like material was stretched in the longitudinal direction at a stretching factor of 4.5 times using a longitudinal stretching machine with rollers heated at 105° C. The longitudinally stretched film was preheated with a film tenter facility (produced by Kyoto Machinery Co., Ltd.) at a preheating temperature of 145° C. for a preheating time of 12 seconds, stretched in the transverse direction at a stretching factor of 3.0 times at a stretching temperature of 145° C., and then heated at 155° C. Hereby, a multilayer porous film was formed. Table 2 summarizes the evaluation results of the multilayer porous film.

### Examples 7 and 10

The pellets (i) used for forming the polypropylene resin porous layer (layer i) and the pellets (ii) used for forming the heat-resistant layer (layer ii) were prepared as in Example 6 using the specific amounts of materials described in Table 2.

The pellets (i) and (ii) were formed into a multilayer nonporous film-like material as in Example 6. The multilayer nonporous film-like material was then subjected to longitudinal stretching, transverse stretching, and a heat treatment as in Example 6, except that the transverse stretching factor was changed to 2.0 times. Table 2 summarizes the evaluation results of the multilayer porous film.

### Examples 8 and 9

The pellets (i) used for forming the polypropylene resin porous layer (layer i) and the pellets (ii) used for forming the heat-resistant layer (layer ii) were prepared as in Example 6 using the specific amounts of materials described in Table 2.

The pellets (i) and (ii) were formed into a multilayer nonporous film-like material as in Example 6. The multilayer nonporous film-like material was then subjected to longitudinal stretching, transverse stretching, and a heat treatment as in Example 6. Table 2 summarizes the evaluation results of the multilayer porous film.

### Comparative Example 5

The pellets (i) used for forming the polypropylene resin porous layer (layer i) were prepared as in Example 6 using the specific amounts of materials described in Table 2.

The pellets (i) were charged into an inner-layer-side extruder and an outer-layer-side extruder and formed into a single-layer nonporous film-like material as in Example 6. The single-layer nonporous film-like material was then subjected to longitudinal stretching, transverse stretching, and a heat treatment as in Example 7. Table 2 summarizes the evaluation results of the single-layer porous film.

### Comparative Examples 6 and 7

The pellets (i) used for forming the polypropylene resin porous layer (layer i) and the pellets (ii) used for forming the heat-resistant layer (layer i) were prepared as in Example 6 using the specific amounts of materials described in Table 2.

The pellets (ii) were charged into an inner-layer-side extruder and the pellets (i) were charged into an outer-layer-side extruder. The pellets (i) and (ii) were formed into a multilayer nonporous film-like material. The multilayer nonporous film-like material was then subjected to longitudinal stretching, transverse stretching, and a heat treatment as in Example 7. Table 2 summarizes the evaluation results of the multilayer porous film.

TABLE 2

| | | | Examples | | | | | Comparative examples | | |
|---|---|---|---|---|---|---|---|---|---|---|
| | | | 6 | 7 | 8 | 9 | 10 | 5 | 6 | 7 |
| Resin composition | Layer i | A-1 | 100 | 100 | 100 | 100 | 100 | 100 | 100 | 100 |
| (mass parts) | | D-1 | 0.2 | 0.2 | 0.2 | 0.2 | 0.2 | 0.2 | 0.2 | 0.2 |
| | Layer ii | A-1 | 70 | 50 | 40 | 40 | 40 | 100 | 50 | 40 |
| | | D-1 | — | — | — | — | — | 0.2 | — | — |
| | | B-1 | 30 | 50 | 50 | 50 | — | — | 50 | 50 |
| | | B-2 | — | — | — | — | 50 | — | — | — |
| | | C-1 | — | — | 10 | 10 | 10 | — | — | 10 |

| Multilayer thickness ratio before | | — | — | — | — | — | Single | 1/1/1 | 1/1/1 |
|---|---|---|---|---|---|---|---|---|---|
| stretching [layer i/layer ii/layer i] | | | | | | | layer | | |
| Multilayer thickness ratio before | | 1/1/1 | 1/1/1 | 1/3/1 | 2/1/2 | 1/1/1 | | — | — |
| stretching [layer ii/layer i/layer ii] | | | | | | | | | |
| Thickness | μm | 26 | 35 | 34 | 24 | 29 | 28 | 29 | 30 |
| Degree of air | sec/100 ml | 71 | 61 | 83 | 27 | 48 | 150 | 102 | 84 |
| permeation | | | | | | | | | |
| β-Crystal activity | — | ◯ | ◯ | ◯ | ◯ | ◯ | ◯ | ◯ | ◯ |
| (DSC) | | | | | | | | | |
| β-Crystal activity | — | ◯ | ◯ | ◯ | ◯ | ◯ | ◯ | ◯ | ◯ |
| (XRD) | | | | | | | | | |
| Coefficient of | — | 0.89 | 0.76 | 0.76 | 0.95 | 0.74 | 0.37 | 0.56 | 1.48 |
| kinetic friction | Evaluation | ◯ | ◯ | ◯ | ◯ | ◯ | X | X | X |
| Area shrinkage | % | 9.5 | 6.1 | 5.0 | 3.9 | 5.0 | 37.4 | 37.7 | 29.6 |
| | Evaluation | ◯ | ◯ | ◯ | ◯ | ◯ | X | X | X |

The results obtained in Examples 6 to 10 confirm that the multilayer porous films according to the second invention, which were constituted by the polypropylene resin porous layer (layer i) and the heat-resistant layers (layer ii) including the polypropylene resin and the inorganic particles, which were stacked on top of one another in the order of the layer ii, the layer i, and the layer ii, had a coefficient of kinetic friction of 0.6 or more and a small area shrinkage of 10% or less regardless of the multilayer thickness ratio between the layer i and the layers ii or the amount of inorganic particles used. When the multilayer porous film has a small area shrinkage, using the multilayer porous film as a component of a lithium-ion secondary battery reduces the misalignment and shrinkage and increases the safety of the battery.

The single-layer porous film prepared in Comparative example 5, which was composed only of the polypropylene resin porous layer (layer i), had a small coefficient of kinetic friction and failed to have a small area shrinkage of 10% or less.

The results obtained in Comparative examples 6 and 7 confirm that, when the multilayer structure of the multilayer porous film was constituted by the layer i, the layer ii, and the layer i stacked on top of one another in this order, the polypropylene resin porous layer (layer i) that did not contain the inorganic particles served as an outermost layer of the multilayer porous film. Consequently, the coefficient of kinetic friction of the multilayer porous film was smaller than 0.6, and the multilayer porous film failed to have a small area shrinkage of 10% or less. In such a case, the safety of the battery may fail to be ensured when the abnormal heat generation in the battery occurs.

### INDUSTRIAL APPLICABILITY

The multilayer porous films according to the first and second inventions may be widely used, as a storage device, in a battery device, such as a nickel metal hydride battery or a lithium-ion secondary battery, or a capacitor device, such as an aluminum electrolytic capacitor, an electric double-layer capacitor, or a lithium-ion capacitor. The multilayer porous films according to the first and second inventions may be used in various application where high air permeability is required and are also suitably used as, for example, a body-fluid-absorbing pad, such as a disposable diaper; a medical material, such as a surgical gown; a clothing material, such as a jacket or a rainwear; a building material, such as a house waterproof material or a heat-insulating material; or a packaging material for desiccants, disposable body warmers, and the like.

In particular, using the multilayer porous film according to the second invention as a battery separator advantageously reduces the shrinkage of the separator which may occur when the abnormal heat generation in the lithium-ion secondary battery occurs and, as a result, enhances the safety of the battery.

Although the present invention has been described in detail with reference to particular embodiments, it is apparent to a person skilled in the art that various modifications can be made therein without departing from the spirit and scope of the present invention.

The present application is based on Japanese Patent Application No. 2015-75154 filed on Apr. 1, 2015, and Japanese Patent Application No. 2015-83460 filed on Apr. 15, 2015, which are incorporated herein by reference in their entirety.

### REFERENCE SIGNS LIST

10 BATTERY SEPARATOR (MULTILAYER POROUS FILM)

20 LITHIUM-ION SECONDARY BATTERY

21 POSITIVE ELECTRODE PLATE

22 NEGATIVE ELECTRODE PLATE

24 POSITIVE ELECTRODE LEAD

25 NEGATIVE ELECTRODE LEAD

26 GASKET

27 POSITIVE ELECTRODE LID

1. A multilayer porous film comprising at least two layers including a first layer and a second layer,
wherein the first layer, layer I, is a porous layer including a polypropylene resin (A) as a main component,
the second layer, layer II is a heat-resistant layer including a resin composition (II),
the resin composition (II) includes a polypropylene resin (A), inorganic particles (B), and a vinyl aromatic elastomer (C), and
the vinyl aromatic elastomer (C) has a melt flow rate (MFR) of 1 g/10 min or less as determined at 230° C. with a load of 2.16 kg.

2. The multilayer porous film according to claim 1, wherein an amount of the vinyl aromatic elastomer (C) is 1 to 30 parts by mass relative to 100 parts by mass of the resin composition (II).

3. The multilayer porous film according to claim 1, wherein the porous layer, layer I, has β-crystal activity.

4. The multilayer porous film according to claim 1, wherein the porous layer, layer I, includes a β-phase-nucleating agent.

5. The multilayer porous film according to claim 1, wherein the multilayer porous film is a stretched film.

6. The multilayer porous film according to claim 1, wherein the multilayer porous film has a degree of air permeation of 100 sec/100 ml or less as determined at 25° C. in accordance with JIS P8117 (2009).

7. The multilayer porous film according to claim 1, wherein an electric resistance of the multilayer porous film in a thickness direction is 0.7 Ω or less as determined at 25° C. after the multilayer porous film has been impregnated with a solution comprising propylene carbonate and ethyl methyl carbonate at a ratio of 1:1 (v/v), the solution comprising 1 M lithium perchlorate.

8. A battery separator comprising the multilayer porous film according to claim 1.

9. A battery comprising the battery separator according to claim 8.

10. A method for producing the multilayer porous film according to claim 1, wherein the method comprises:
coextruding a polypropylene resin composition for constituting the layer I and the resin composition (II) including the polypropylene resin (A), the inorganic particles (B), and the vinyl aromatic elastomer (C) for constituting the layer II, thereby forming a multilayer nonporous film-like material; and
stretching the multilayer nonporous film-like material at least uniaxially to make the material porous,
wherein the method does not comprise removing additives with a solvent.

11. A multilayer porous film comprising at least three layers including a layer i and layers ii, the layer i and the layers ii being stacked in an order of the layer ii/the layer i/the layer ii,
wherein the layer i is a polypropylene resin porous layer,
wherein the layers ii are heat-resistant layers each including 20 to 80 parts by mass of a polypropylene resin and 80 to 20 parts by mass of inorganic particles, relative to 100 parts by mass of a total amount of the polypropylene resin and the inorganic particles, and
wherein a surface of each of the layers ii has a coefficient of kinetic friction of 0.6 or more on a polyethylene terephthalate film having an arithmetic average roughness Ra of 0.3 or less as determined in accordance with JIS K7125 (1999).

12. The multilayer porous film according to claim 11, wherein the polypropylene resin porous layer has β-crystal activity.

13. The multilayer porous film according to claim 11, wherein the polypropylene resin porous layer includes a β-phase-nucleating agent.

14. The multilayer porous film according to claim 11, wherein the multilayer porous film being is a stretched film.

15. The multilayer porous film according to claim 11, wherein an area shrinkage of the multilayer porous film which occurs when the multilayer porous film is heated to 200° C. is 10% or less.

16. A battery separator comprising the multilayer porous film according to claim 11.

17. A battery comprising the battery separator according to claim 16.

18. A method for producing the multilayer porous film according to claim 11, wherein the method comprises:
coextruding a polypropylene resin composition for constituting the layer i and a resin composition including 20 to 80 parts by mass of the polypropylene resin and 80 to 20 parts by mass of the inorganic particles for constituting the layer ii, thereby forming a multilayer nonporous film-like material such that the multilayer nonporous film-like material has a structure including the layer ii, the layer i, and the layer ii stacked in this order; and
stretching the multilayer nonporous film-like material at least uniaxially to make the material porous,
wherein the method does not comprise removing additives with a solvent.
